(19) United States
(12) Patent Application Publication
(10) Pub. No.: US 2015/0035509 A1
(43) Pub. Date: Feb. 5, 2015

(54) CONTROL CIRCUIT AND DC-DC CONVERTER

(71) Applicant: SEMICONDUCTOR ENERGY LABORATORY CO., LTD., Atsugi-shi (JP)

(72) Inventors: Jun KOYAMA, Sagamihara (JP); Kei TAKAHASHI, Isehara (JP); Takuro OHMARU, Isehara (JP)

(21) Appl. No.: 14/330,016

(22) Filed: Jul. 14, 2014

(30) Foreign Application Priority Data
Jul. 31, 2013 (JP) 2013-159082
Mar. 14, 2014 (JP) 2014-051689

(51) Int. Cl. H02M 3/157

(52) U.S. Cl. CPC H02M 3/157
USPC 323/283

(57) ABSTRACT

To provide a control circuit in a DC-DC converter, which includes transistors with the same conductivity type. The control circuit generates a pulse signal (GS), and includes a hysteresis comparator, a logic unit, a digital-analog converter circuit, and a comparator. The hysteresis comparator converts a signal (FB) based on an output voltage of the DC-DC converter into a digital signal (comp). The logic unit generates, in accordance with the signal comp, a pulse width modulation signal (pwm) determining a pulse width of the signal GS. The logic unit also divides a reference clock signal to generate an m-bit (m is greater than or equal to 2) second digital signal. The digital-analog converter circuit converts the m-bit second digital signal into an analog signal to generate a 2^{m}-level triangular wave signal. The comparator compares the signal pwm with the triangular wave signal to output the comparison result as the signal GS.

### BACKGROUND OF THE INVENTION

1. Field of the Invention

The present invention relates to an object, a method, or a manufacturing method. The present invention also relates to a process, a machine, manufacture, or a composition of matter. In particular, one embodiment of the present invention relates to a semiconductor device, a display device, a light-emitting device, a power storage device, a driving method thereof, or a manufacturing method thereof. More particularly, one embodiment of the present invention relates to a DC-DC converter, a control circuit thereof, and the like.

Note that in this specification, a semiconductor device refers to a device that utilizes semiconductor characteristics, and means a circuit including a semiconductor element (e.g., a transistor or a diode), a device including the circuit, and the like. The semiconductor device also means any device that can function by utilizing semiconductor characteristics. For example, an integrated circuit, and a chip including an integrated circuit are all semiconductor devices. Moreover, a display device, a light-emitting device, a lighting device, an electronic device, and the like include a semiconductor device in some cases.

2. Description of the Related Art

A DC-DC converter is a constant voltage circuit and has a function of converting a direct-current (DC) voltage into another DC voltage. Known examples of the DC-DC converter include a switching DC-DC converter and a linear DC-DC converter.

For example, a switching DC-DC converter that has been disclosed includes a combination of a transistor with a silicon (Si) channel (hereinafter referred to as a Si transistor) and a transistor with an oxide semiconductor (OS) channel (hereinafter referred to as an OS transistor) (Patent Documents 1 and 2).

### REFERENCE

### Patent Document

[Patent Document 1] Japanese Published Patent Application No. 2012-019682
[Patent Document 2] Japanese Published Patent Application No. 2012-100522

### SUMMARY OF THE INVENTION

As disclosed in Patent Documents 1 and 2, a switching DC-DC converter includes a control circuit that generates a pulse signal for controlling on/off of a switch, and a voltage generation circuit that generates a DC voltage from a current flowing through the switch. The control circuit is generally manufactured using Si transistors by a CMOS process.

It is now difficult to control the conductivity type of an oxide semiconductor layer by the addition of a dopant; therefore, a p-channel OS transistor has not been realized yet though an n-channel OS transistor can be obtained using an oxide semiconductor layer. Accordingly, a CMOS circuit including OS transistors has not been in practical use.

An OS transistor can be used at a higher temperature than a Si transistor. FIGS. 22A and 22B show the measurement results of the temperature characteristics of fabricated transistors. FIG. 22A shows the measurement results of OS transistors and FIG. 22B shows the measurement results of Si transistors. At temperatures (Tmp) of −25° C., 50° C., and 150° C., gate voltage V_{G}-drain current I_{D} characteristics and gate voltage V_{G}-electric field effect mobility μ_{FE} characteristics were measured. The drain voltage V_{D} at the measurement was 1 V.

The OS transistor has a channel length L of 0.45 μm and a channel width W of 10 μm, and an equivalent oxide thickness Tox of a gate insulating layer is 20 nm. The Si transistor has an L of 0.35 μm and a W of 10 μm, and an equivalent oxide thickness Tox of a gate insulating layer is 20 nm.

An oxide semiconductor layer in the OS transistor is made of an In—Ga—Zn-based oxide. The Si transistor is formed using an SOI single crystal silicon wafer.

FIGS. 22A and 22B show that the OS transistor has low temperature dependence of gate voltage at which a drain current starts flowing, which is substantially the same as that of the single crystal Si transistor. The off-state current of the OS transistor is lower than or equal to the lower measurement limit independently of temperature. On the contrary, the off-state current of the single crystal Si transistor largely depends on the temperature. According to the measurement results of FIG. 22B, the off-state current of the single crystal Si transistor rises at 150° C., and a sufficiently high current on/off ratio cannot be obtained.

In view of the above, an object of one embodiment of the present invention is to provide a circuit that generates a pulse signal and can be manufactured using transistors with the same conductivity. Another object of one embodiment of the present invention is to provide a pulse signal generation circuit that can be used as a control circuit of a DC-DC converter, to provide a control circuit of a DC-DC converter that can be produced using transistors with the same conductivity, and the like.

Still another object of one embodiment of the present invention is to provide a DC-DC converter that can be used in a wider range of temperature. In particular, an object of one embodiment of the present invention is to provide a DC-DC converter that can be used at a high temperature. An object of one embodiment of the present invention is also to provide a new semiconductor device.

Note that the description of a plurality of objects does not disturb the existence of each object. One embodiment of the present invention does not necessarily achieve all the objects. Objects other than those listed above are apparent from the description of the specification, drawings, and claims, and also such objects could be an object of one embodiment of the present invention.

One embodiment of the present invention is a control circuit that generates a pulse signal and has a function of modulating a pulse width of a pulse signal in accordance with a change in a voltage of an input signal. The control circuit includes an analog-digital converter circuit, a logic unit, a digital-analog converter circuit, and a comparator. The analog-digital converter circuit has a function of generating a first digital signal corresponding to the voltage of the input signal. The logic unit has a function of generating a pulse width modulation signal determining a pulse width of a pulse signal in accordance with the first digital signal, and also has a function of dividing an input reference clock signal to generate an m-bit (m is greater than or equal to 2) second digital signal. The digital-analog converter circuit has a function of converting the m-bit (m is greater than or equal to 2) second digital signal into an analog signal to generate a 2^{m}-level triangular wave signal. The comparator has a function of comparing the pulse width modulating signal with the triangular wave signal to output the comparison result as the pulse signal.

The control circuit of the above embodiment can be formed using transistors with the same conductivity, or OS transistors.

The control circuit of the above embodiment can be used as a control circuit of a DC-DC converter.

One embodiment of the present invention allows a new semiconductor device to be provided. It is possible to provide, for example, a circuit that generates a pulse signal and can be manufactured using transistors with the same conductivity. It is also possible to provide a control circuit of a DC-DC converter that can be formed using transistors with the same conductivity. Furthermore, a DC-DC converter that can be used in a wider range of temperature can be provided.

### BRIEF DESCRIPTION OF THE DRAWINGS

In the accompanying drawings:

FIG. 1 is a block diagram illustrating an example of a configuration of a DC-DC converter;

FIGS. 2A and 2B are block diagrams each illustrating an example of a configuration of a voltage converter circuit and a feedback circuit (FIG. 2A: step-up converter, FIG. 2B: step-down converter);

FIG. 3 is a block diagram illustrating an example of a configuration of a control circuit (CTRL) in the DC-DC converter;

FIG. 4 is a block diagram illustrating an example of a configuration of the DC-DC converter;

FIG. 5 is a block diagram illustrating an example of a configuration of a circuit (AVEC) in the control circuit;

FIG. 6 is a block diagram illustrating an example of a configuration of a circuit (DUTYC);

FIGS. 7A and 7B are respectively a block diagram and a circuit diagram illustrating an example of a configuration of a digital-analog converter circuit (DAC);

FIG. 8 is a block diagram illustrating an example of a configuration of a comparator, a hysteresis comparator, and a buffer circuit;

FIGS. 9A and 9B are respectively a block diagram and a circuit diagram illustrating an example of a configuration of a comparator (CMP_A);

FIGS. 10A and 10B are respectively a block diagram and a circuit diagram illustrating an example of a configuration of a power source circuit in the CMP_A;

FIGS. 11A and 11B are respectively a block diagram and a circuit diagram illustrating an example of a configuration of an inverter circuit (INVA) in the CMP_A;

FIGS. 12A and 12B are respectively a block diagram and a circuit diagram illustrating an example of a configuration of a differential amplifier circuit (AMPA) in the CMP_A;

FIGS. 13A and 13B are respectively a block diagram and a circuit diagram illustrating an example of a configuration of a differential amplifier circuit (AMPB) in the CMP_A;

FIGS. 14A and 14B are respectively a block diagram and a circuit diagram illustrating an example of a configuration of a NAND gate circuit (NAND_A) in the hysteresis comparator;

FIGS. 15A and 15B are respectively a block diagram and a circuit diagram illustrating an example of a configuration of a buffer circuit (BUF_A);

FIG. 16A is a top view illustrating an example of a structure of an OS transistor, FIG. 16B is a cross-sectional view along line B1-B2 in FIG. 16A, and FIG. 16C is a cross-sectional view along line C1-C2 in FIG. 16A;

FIG. 17A is a top view illustrating an example of a structure of an OS transistor, FIG. 17B is a cross-sectional view along line B3-B4 in FIG. 17A, and FIG. 17C is a cross-sectional view along line C3-C4 in FIG. 17A;

FIG. 18 illustrates examples of structures of electronic appliances;

FIGS. 19A and 19B illustrate an example of a structure of an electronic device;

FIGS. 20A and 20B illustrate an example of a structure of an electronic device;

FIGS. 21A to 21D illustrate examples of structures of electronic devices;

FIGS. 22A and 22B are graphs showing the measurement results of temperature characteristics of an OS transistor and a single crystal Si transistor, respectively;

FIG. 23 is a block diagram illustrating an example of the configuration of the DC-DC converter;

FIG. 24 is a block diagram illustrating a fabricated control circuit;

FIG. 25 is an optical micrograph of the fabricated control circuit;

FIG. 26 shows waveforms of an input signal and an output signal of a comparator that were measured with an oscilloscope;

FIG. 27 is a diagram illustrating an operation testing method of a DC-DC converter; and

FIG. 28 is a graph showing the power efficiency of the fabricated DC-DC converter relative to load power, and the current consumed in the control circuit.

### DETAILED DESCRIPTION OF THE INVENTION

Embodiments of the present invention will be described in detail below with reference to the drawings. Note that the present invention is not limited to the following description. It will be readily appreciated by those skilled in the art that modes and details of the present invention can be modified in various ways without departing from the spirit and scope of the present invention. The present invention therefore should not be construed as being limited to the following description of the embodiments and example.

In the drawings used for the description of embodiments of the present invention, the same portions or portions having a similar function are denoted by the same reference numerals, and the repeated description thereof is omitted.

### Embodiment 1

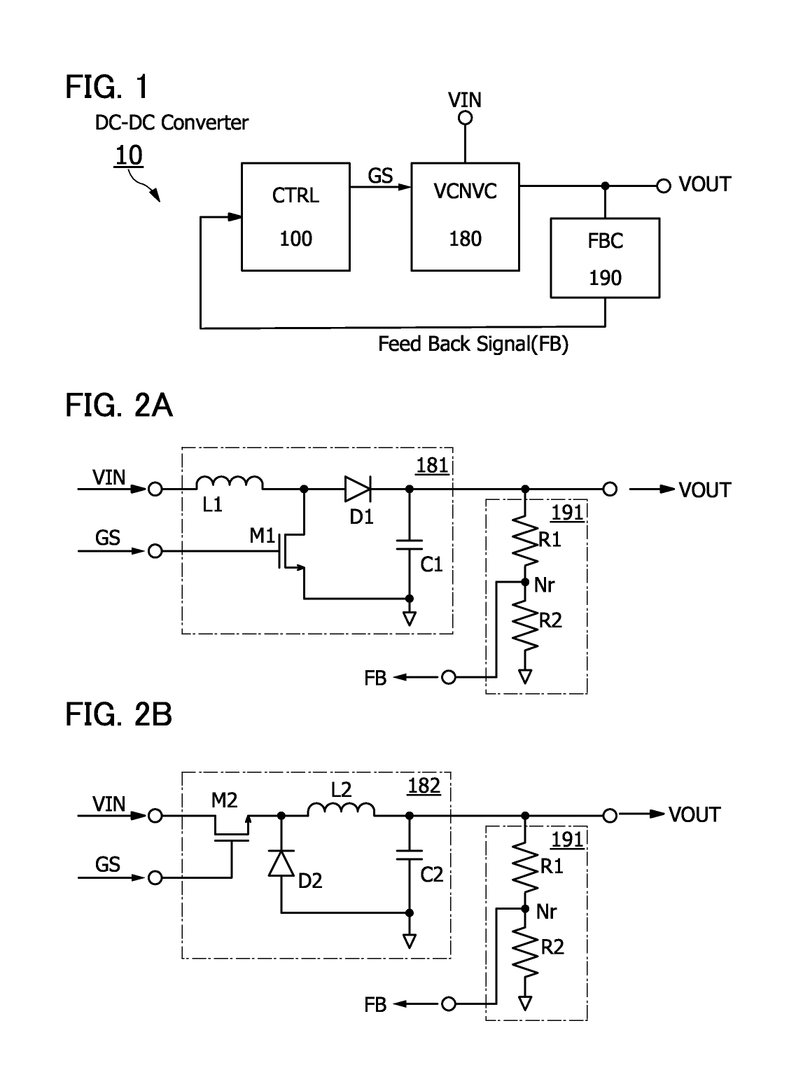

A semiconductor device of this embodiment will be described with reference to FIG. 1, FIGS. 2A and 2B, FIG. 3 to FIG. 6, FIGS. 7A and 7B, FIG. 8, FIGS. 9A and 9B, FIGS. 10A and 10B, FIGS. 11A and 11B, FIGS. 12A and 12B, FIGS. 13A and 13B, FIGS. 14A and 14B, and FIGS. 15A and 15B. Here, a switching DC-DC converter will be described as the semiconductor device.

### <<DC-DC Converter>>

FIG. 1 is a block diagram illustrating an example of a configuration of a DC-DC converter.

A DC-DC converter 10 illustrated in FIG. 1 has a function of converting an input voltage VIN into an output voltage VOUT, and includes a control circuit (CTRL) 100, a voltage converter circuit (VCNVC) 180, and a feedback circuit (FBC) 190.

Note that in the description below, the input voltage VIN is simply referred to as the voltage VIN or the VIN in some cases. The same applies to other voltages, signals, circuits, signal lines, and the like.

A DC power source such as a battery is used for the VIN. In the case where an alternate-current (AC) power source such as a commercial power source is used, the voltage output from the AC power source may be converted into a DC voltage before being input to the DC-DC converter 10.

The CTRL 100 has a function of generating a pulse signal (GS) for controlling on/off of a switch in the VCNVC 180.

The VCNVC 180 is a circuit having a function of converting the DC voltage VIN into the DC voltage VOUT. The VCNVC 180 includes a transistor serving as a switch. When the transistor is periodically turned on and off, the input voltage VIN is stepped up or down into the voltage VOUT. The magnitude of the VOUT can be controlled by a change in the on-off duty ratio of the transistor.

The CTRL 100 controls the duty ratio of the pulse signal GS so that the constant voltage VOUT is output from the VCNVC 180. Hence, a feedback signal (FB) generated in the FBC 190 is input to the CTRL 100. The FBC 190 monitors a change in the voltage of an output terminal and outputs the monitoring result as the signal FB. The signal FB is based on the voltage VOUT.

The CTRL 100 controls the VCNVC 180 depending on the signal FB by a pulse width modulation (PWM) method for changing the duty ratio of the pulse signal GS.

### <<Voltage Converter Circuit (VCNVC), Feedback Circuit (FBC)>>

A typical example of the VCNVC 180 is a chopper circuit. FIG. 2A illustrates an example of a step-up chopper circuit and FIG. 2B illustrates an example of a step-down chopper circuit.

FIGS. 2A and 2B also illustrate an example of a circuit configuration of the FBC 190. An example of the FBC 190 is a divider circuit. FIGS. 2A and 2B show an example in which a divider circuit 191 is used as the FBC 190. The divider circuit 191, which is a resistor divider circuit, includes two resistors R1 and R2 connected in series. A change in the voltage of a node Nr is output from the divider circuit 191 as the signal FB.

### <Step-Up Chopper>

A chopper circuit 181 in FIG. 2A includes a transistor M1, a coil L1, a diode D1, and a capacitor C1. The chopper circuit 181 satisfies VIN<VOUT.

The transistor M1 serves as a switch. Here, the transistor M1 is an n-channel transistor. The pulse signal GS is input to a gate of the transistor M1. In the chopper circuit 181, the coil L1 is referred to as a choke coil in some cases. The capacitor C1 serves as a circuit for smoothing a voltage output from the diode D1.

When the transistor M1 is turned on, a current flows between an input terminal of the VIN and the transistor M1. Then, the current energy is stored in the coil L1 as a magnetic energy. When the transistor M1 is turned off, the energy stored in the coil L1 produces electromotive force, so that a drain voltage of the transistor M1 is higher than the VIN. As a result, a current flows from the coil L1 to the diode D1 to charge the capacitor C1. A voltage based on the charge accumulated in the capacitor C1 is output as the VOUT.

### <Step-Down Chopper>

As illustrated in FIG. 2B, a chopper circuit 182 also includes a transistor M2, a coil L2, a diode D2, and a capacitor C2. The chopper circuit 182 satisfies VIN>VOUT. Each component in the chopper circuit 182 has a function similar to that in the chopper circuit 181.

When the transistor M2 is turned on, a current flows between an input terminal of the VIN and an output terminal of the VOUT to charge the capacitor C2. This current also produces electromotive force in the coil L2, so that the voltage of the capacitor C2 is lower than the voltage VIN. When the transistor M2 is turned off, a closed circuit is made up of the diode D2, the coil L2, and the capacitor C2. Accordingly, a voltage based on the charge accumulated in the capacitor C2 is output as the VOUT.

Here, the DC-DC converter 10 is a digital control converter. In the CTRL 100, the signal FB is converted into a digital signal, and the pulse width of the signal GS is determined from the results of arithmetic operation of the digital signal. A more specific configuration of the CTRL 100 will be described below with reference to drawings.

### <<CTRL 100>>

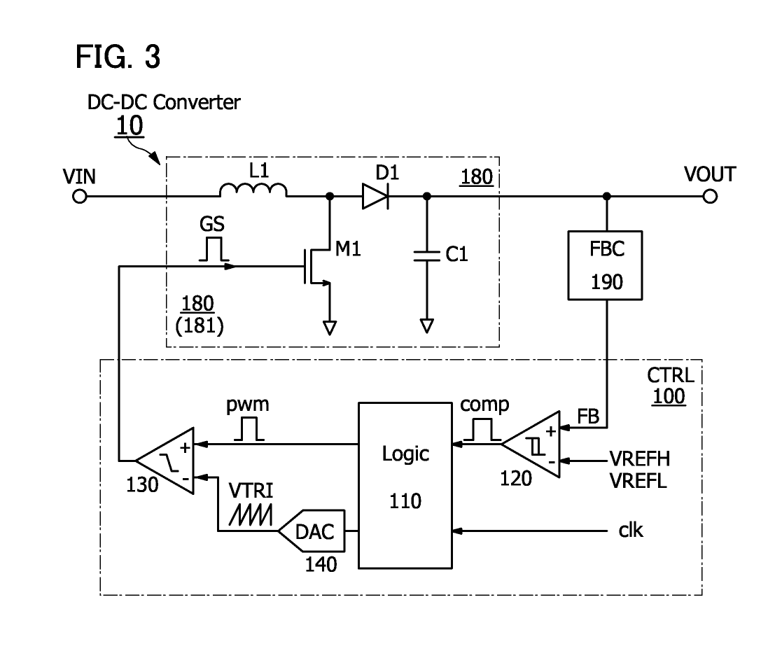

FIG. 3 is a block diagram illustrating an example of a configuration of the DC-DC converter 10. FIG. 3 shows an example in which the chopper circuit 181 and the divider circuit 191 illustrated in FIG. 2A are used as the VCNVC 180 and the FBC 190, respectively.

As illustrated in FIG. 3, the CTRL 100 includes a logic unit 110, a hysteresis comparator 120, a comparator 130, and a digital-analog converter circuit (DAC) 140.

The hysteresis comparator 120 serves as an analog-digital converter circuit which converts the voltage of the signal FB into a digital signal to generate a signal comp. Specifically, the hysteresis comparator 120 compares reference voltages VREFH and VREFL with the voltage of the signal FB, and outputs the comparison result to the logic unit 110 as an “H” (high level) signal comp or an “L” (low level) signal comp.

The logic unit 110 has a function of generating a signal pwm, a pulse width modulation signal. The logic unit 110 performs arithmetic operation on the signal comp input from the hysteresis comparator 120, and determines a value for setting the duty ratio of the signal GS. That value is output as the signal pwm. In other words, the logic unit 110 is a circuit for performing arithmetic operation on the signal FB (the signal comp) that has been digitalized in the hysteresis comparator 120, and generating the digital signal pwm that determines the duty ratio of the signal GS.

The CTRL 100 also generates from a clock signal CLK an m-bit (m is an integer of 2 or more) digital signal which is to be processed in the DAC 140. The m-bit digital signal is input to the DAC 140. The DAC 140 converts the digital signal into an analog signal to generate and output a 2^{m}-level triangular wave signal VTRI. That is, the DAC 140 serves as a triangular wave generation circuit.

The comparator 130 generates the signal GS. The comparator 130 compares the voltage of the signal VTRI with the voltage of the signal pwm. Whether the signal GS is high level or low level is determined by the comparison result. That is, in the CTRL 100, the duty ratio of the signal GS is controlled by the signal pwm.

In the CTRL 100, like in a common analog control circuit, the comparator generates the signal GS controlling the transistor M1. However, the CTRL 100 is different from the analog control circuit in that a digital signal is used for generating a triangular wave and processing an error amplifier (an integrator circuit) amplifying an error of the VOUT.

In our research regarding to OS transistors, an operational amplifier including only OS transistors would be difficult to have necessary performance. Thus, when a circuit configuration includes no error amplifier (operational amplifier) like the CTRL 100, it is possible to provide a control circuit capable of generating the signal GS by a pulse width modulation method with use of transistors with the same conductivity, in particular, OS transistors.

### <Example of Configuration of CTRL: 1>

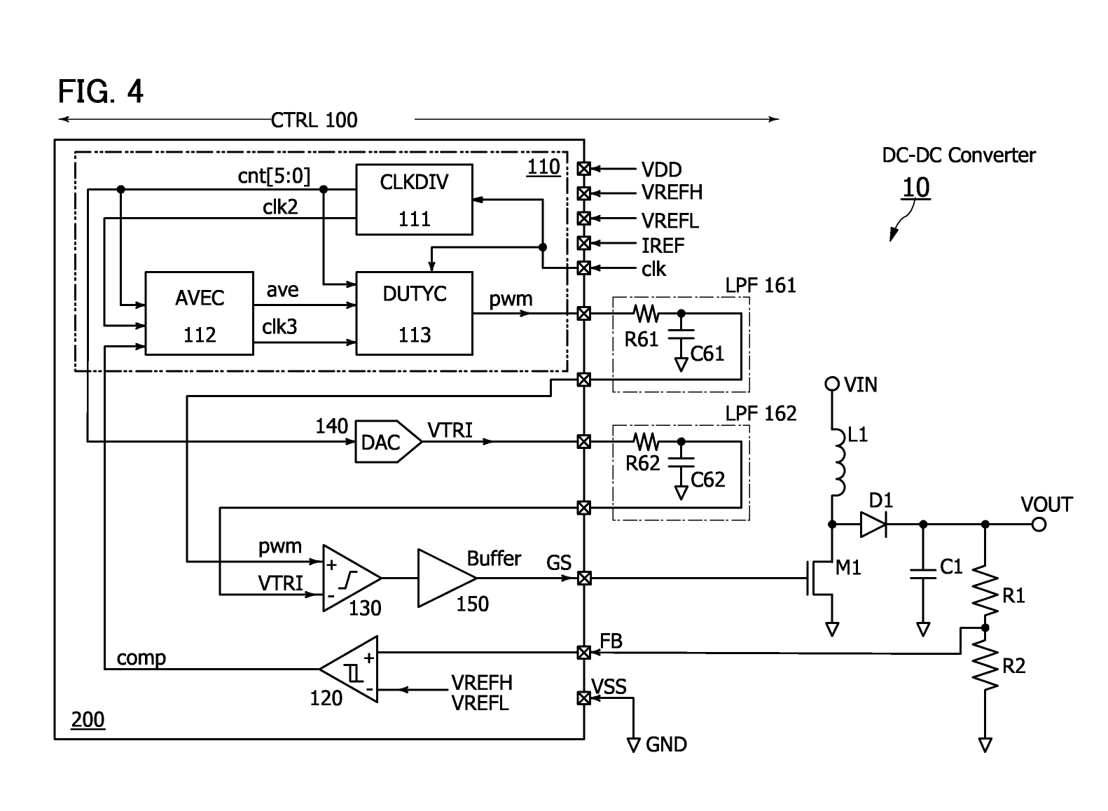

FIG. 4 illustrates an example of a more specific configuration of the CTRL 100 (DC-DC converter 10). FIG. 4 shows an example of a step-up converter in which the chopper circuit 181 is used as the VCNVC 180 and the divider circuit 191 is used as the FBC 190. It is needless to say that the chopper circuit 182 can be provided instead of the chopper circuit 181, in which case a step-down converter is obtained.

The CTRL 100 in FIG. 4 includes the logic unit 110, the hysteresis comparator 120, the comparator 130, and the DAC 140. The CTRL 100 also includes a buffer circuit 150 and two low-pass filter circuits (LPFs) 161 and 162. These circuits (150, 161, 162) are provided as necessary.

The LPF 161 includes a resistor R61 and a capacitor C61, and the LPF 162 includes a resistor R62 and a capacitor C62. The signal pwm output from the logic unit 110 is input to the DAC 140 via the LPF 161, and the signal VTRI output from the DAC 140 is input to the comparator 130 via the LPF 162.

In the CTRL 100 in FIG. 4, a circuit block 200 is an example of a circuit group that can be easily integrated on one chip. The circuit block 200 is provided with, through terminals, voltages (e.g., VDD, VSS, VREFH, VREFL, IREF) and signals (e.g., reference clock signal clk) necessary for the operation of the internal circuit. Note that

FIG. 4 shows an example in which the low power source voltage VSS is a ground potential (GND).

### <Logic Unit 110>

The logic unit 110 includes three circuits (111, 112, 113).

### [CLKDIV Circuit]

The circuit (CLKDIV) 111 is a divider circuit. The CLKDIV 111 divides the clock signal clk into 1 to m, thereby generating m clock signals. The m clock signals are input to the DAC 140 and the DUTYC 113 as m-bit digital signals cnt[m-1:0]. Some of the clock signals are used as internal clock signals of the logic unit 110.

For example, the CLKDIV 111 can be constituted by a synchronous m-bit counter circuit. FIG. 4 shows an example of m=6. The CLKDIV 111 divides the clk into 1 to 6, thereby generating 6-bit digital signals cnt[5:0]. One of the signals cnt[5:0] is input to the AVEC 112 as a clock signal clk2. Here, the clk is divided into three and output as the clk2 (⅛ frequency) to the AVEC 112.

### [AVEC]

The circuit (AVEC) 112 counts up a signal comp output from the hysteresis comparator 120 with a constant period and calculates the average of the counted values. A signal ave represents the calculated average value.

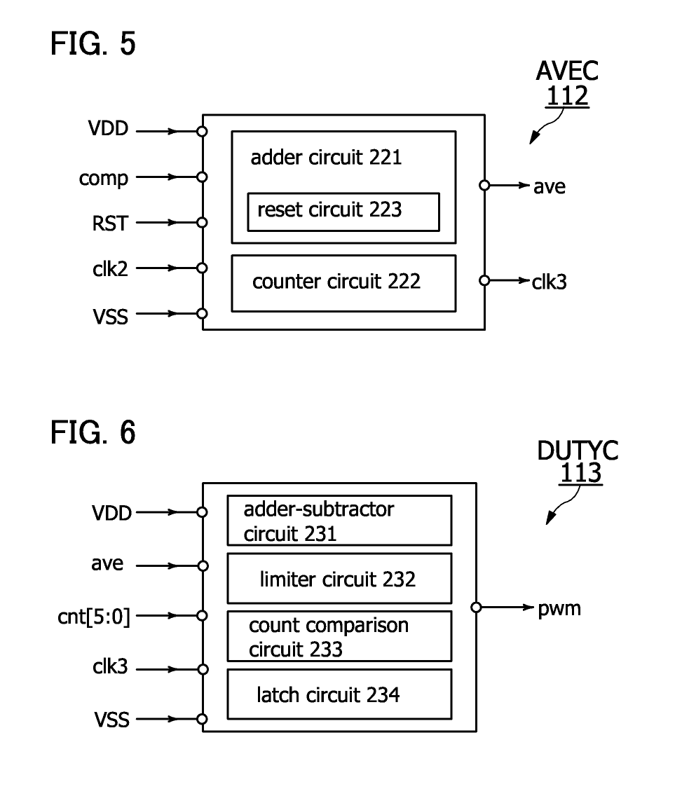

The AVEC 112 includes, for example, a synchronous n-bit counter circuit 222 and an n-bit adder circuit 221 as illustrated in FIG. 5. The adder circuit 221 is provided with a reset circuit 223 which resets the counted value. Here, the case of n=3 is described as an example.

The counter circuit 222 divides the clock signal clk2 into 1 to 3, thereby generating three clock signals used in the adder circuit 221. One of the clock signals is output as a clock signal clk3 to the DUTYC 113. For example, the clk3 is obtained by dividing the clk2 into 2. In that case, the frequency of the clk3 is 1/512 that of the clk.

The adder circuit 221 has a function of adding the value of the comp (1 or 0) every count. Specifically, whether the comp is “H” or not is determined, and if the comp is “H”, +1 is added to the counted value. Furthermore, the adder circuit 221 calculates the average value of the counted values every certain counts (e.g., every 7 counts), and outputs the average value as the signal ave. In this example, “H” signal is output as the signal ave when the counted value is greater than or equal to 4, and “L” signal is output when the counted value is less than 4. The counted value of the adder circuit 221 is reset to 0 every 8 counts by the reset circuit 223. The processing of the reset circuit 223 is controlled by a reset signal RST input from the outside of the logic unit 110.

### [DUTYC]

The circuit (DUTYC) 113 generates, based on the signal ave output from the AVEC 112, the signal pwm which determines the duty ratio of the signal GS. The DUTYC 113 compares the output signal ave with a value (DUTY ratio setting value) that is input from the outside to determine the duty ratio of the GS, and sets the logic level of the signal pwm to “H” or “L” on the basis of the comparison results.

The DUTYC 113 includes, for example, an adder-subtractor circuit 231, a limiter circuit 232, a count comparison circuit 233, and a latch circuit 234 as illustrated in FIG. 6. Here, the DUTYC 113 processes a 6-bit digital signal.

As the initial value of the DUTY ratio setting value, a 6-bit signal is input to the DUTYC 113 from the outside of the CTRL 100. The adder-subtractor circuit 231 has a function of adding +1 or −1 to the DUTY ratio setting value in accordance with the value of the signal ave (0 or 1). Here, when the ave is “H”, addition is performed such that DUTY ratio setting value=DUTY ratio setting value +1; when the ave is “L”, subtraction is performed such that DUTY ratio setting value=DUTY ratio setting value −1.

The count comparison circuit 233 has a function of counting a 6-bit signal cnt[5:0]. In other words, the count comparison circuit 233 counts a value from 1 to 64 in one period of the processing of the DUTYC 113. Here, the counted value in the count comparison circuit 233 is referred to as digCNT. In the count comparison circuit 233, arithmetic operation is performed on the digCNT every count, and the operation result is latched in the latch circuit 234. The signal output from the latch circuit 234 is the signal pwm.

The count comparison circuit 233 latches the “H” signal in the latch circuit 234 when the digCNT is 0 or 1. When the digCNT is equal to the DUTY ratio setting value, the count comparison circuit 233 latches the “L” signal in the latch circuit 234. For example, if the DUTY ratio setting value is 32, the pwm is transferred from “L” to “H” when the digCNT reaches 32. In that case, the duty ratio of the signal GS is set to 50% by the pwm.

The limiter circuit 232 controls the arithmetic operation of the adder-subtractor circuit 231 and determines the maximum and minimum values of the DUTY ratio setting value. For example, the maximum and minimum values of the DUTY ratio setting value are set to 56 and 8, respectively. As a result, it is possible to determine the potential level of the pwm as appropriate every 64 counts.

The circuits (111 to 113) in the logic unit 110 can be obtained by combining basic logic circuits including transistors with the same conductivity, such as an inverter circuit, a NOR gate circuit, and an AND gate circuit.

### <DAC>

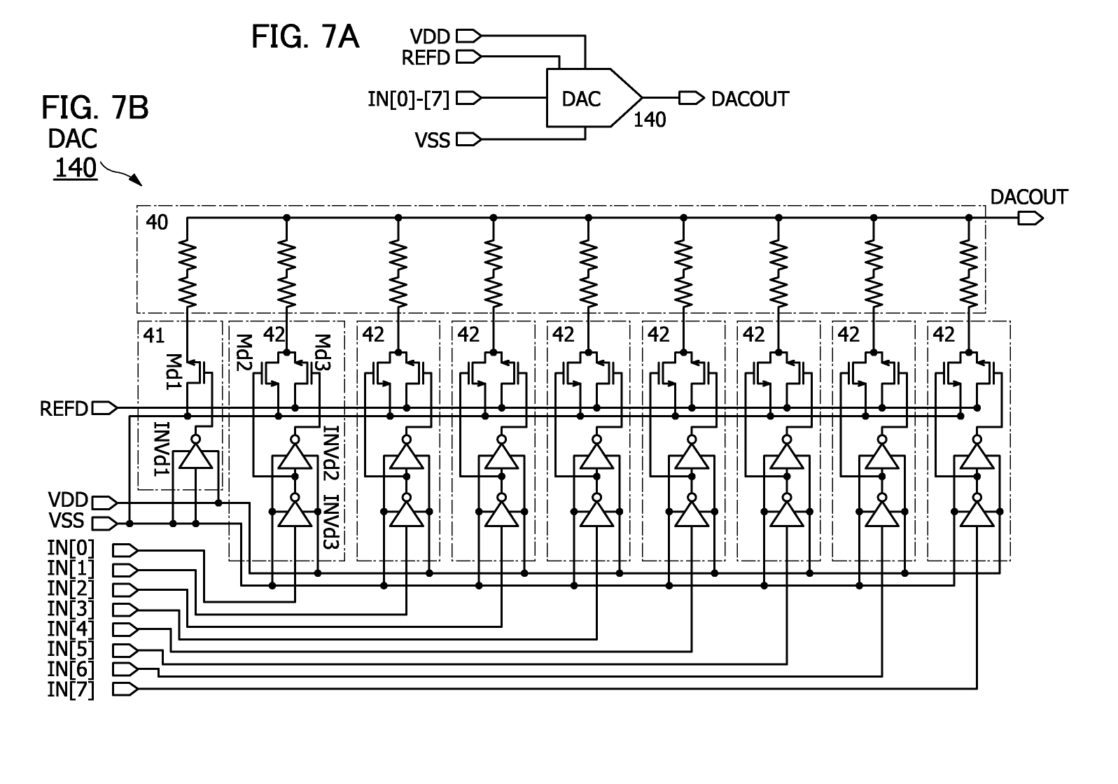

FIG. 7A is a block diagram illustrating an example of a configuration of the DAC 140, and FIG. 7B is a circuit diagram of the DAC 140. Here, the DAC 140 is a 6-bit DAC including an R-2R ladder resistor circuit. In that case, a 64 (2⁶)-level triangular wave signal VTRI is generated in the DAC 140.

The DAC 140 includes input terminals for voltages (VDD, VSS, REFD), input terminals for digital signals (IN[0] to IN[7]), and an output terminal (DACOUT). The voltage REFD is a reference voltage for analog conversion. The VDD is higher than the REFD.

The 6-bit signal cnt[5:0] output from the CLKDIV 111 is input to 6 terminals of the 8 input terminals IN[0] to IN[7]. For example, the VSS is input to IN[0] and IN[1], and the signals cnt[0] to cnt[6] are input to IN[2] to IN[7], respectively.

The signal cnt[5:0] input to the DAC 140 is converted into an analog signal and output from the output terminal DACOUT as the triangular wave signal VTRI.

In the example of FIG. 7B, the DAC 140 includes a ladder resistor circuit 40 including 18 resistors, a circuit 41, and 8 circuits 42. The circuit 41 includes a transistor Md1 and an inverter circuit INVd1. The circuit 42 includes transistors (Md2, Md3) and inverter circuits (INVd2, INVd3).

### <<Hysteresis Comparator, Comparator, and Buffer Circuit>>

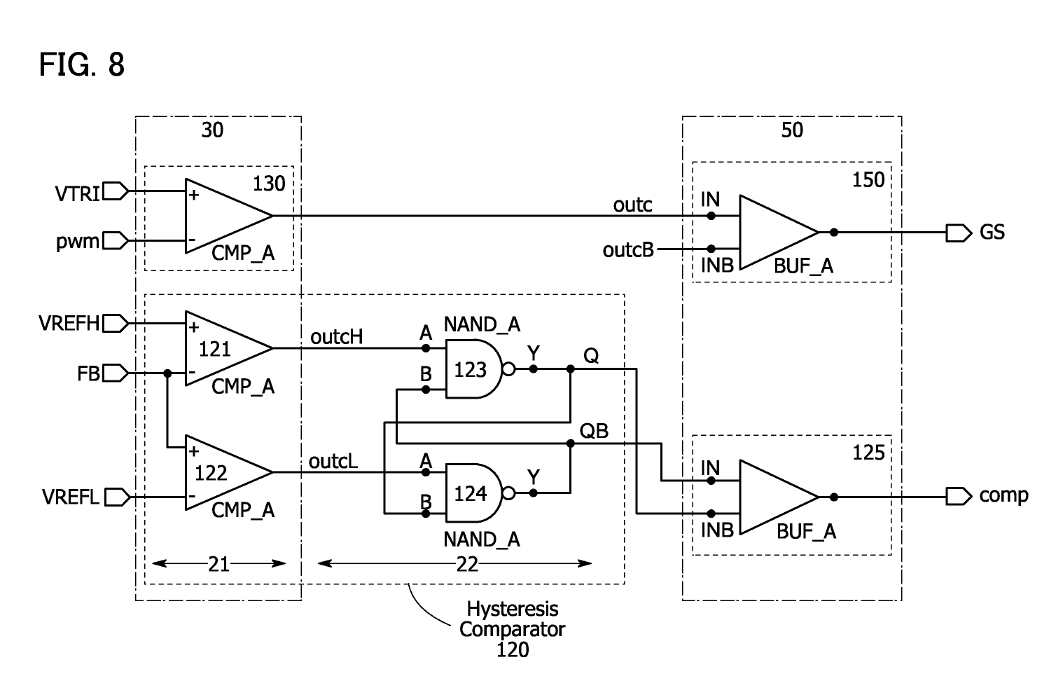

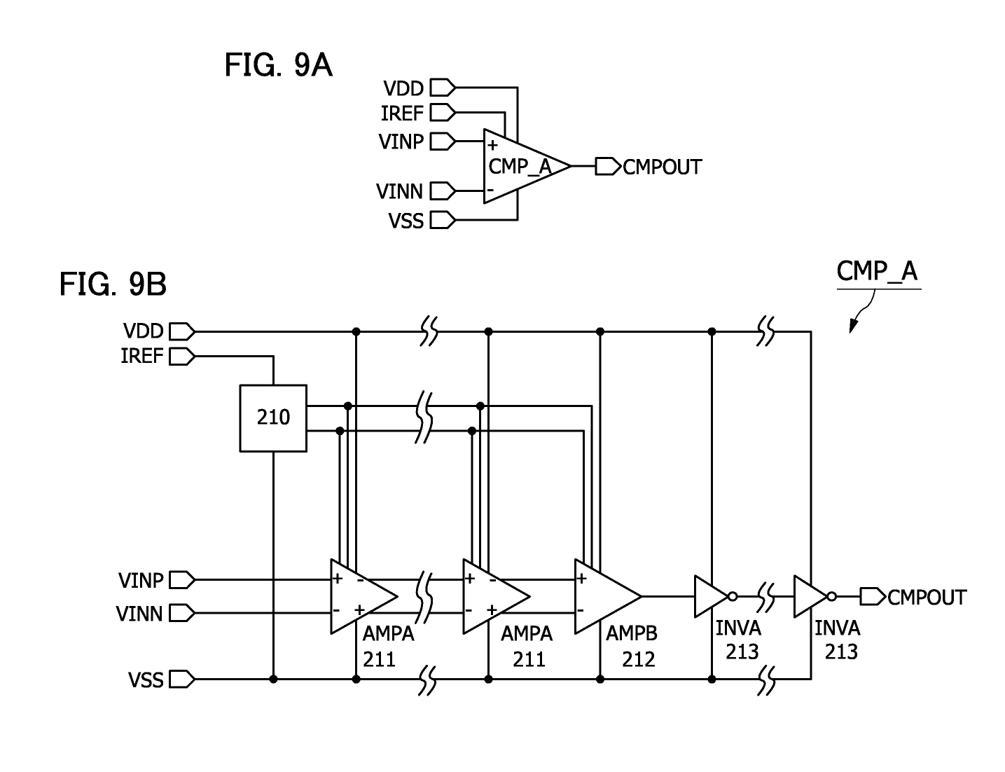

Hereinafter, configurations of the hysteresis comparator 120, the comparator 130, and the buffer circuit 150 will be described with reference to FIG. 8, FIGS. 9A and 9B, FIGS. 10A and 10B, FIGS. 11A and 11B, FIGS. 12A and 12B, FIGS. 13A and 13B, FIGS. 14A and 14B, and FIGS. 15A and 15B. Like the logic unit 110, the hysteresis comparator 120, the comparator 130, and the buffer circuit 150 can be constituted by transistors with the same conductivity. Here, the configurations of these circuits will be described using n-channel transistors as an example.

FIG. 8 is a block diagram illustrating an example of the configurations of the hysteresis comparator 120, the comparator 130, and the buffer circuit 150. The hysteresis comparator 120 includes comparators 121 and 122, a NAND gate circuit 123, and a NAND gate circuit 124. FIG. 8 shows an example in which the output of the hysteresis comparator 120 is connected to a buffer circuit 125.

The comparator 130 and the comparators (121, 122) can be constituted by the same comparator circuit (CMP_A). The buffer circuit 150 and the buffer circuit 125 can be constituted by the same buffer circuit (BUF_A). Accordingly, in the layout of the circuit block 200 (see FIG. 4), three circuits CMP_A can be integrated in a region (a comparator unit 30), and two buffer circuits (BUF_A) can be integrated in a region (a buffer unit 50).

Furthermore, the NAND gate circuits (123, 124) can also be constituted by the same circuit NAND_A. The two circuits NAND_A may be integrated in a region where logic circuits constituting the logic unit 110 are formed.

The signal VTRI output from the DAC 140 is input to a non-inverting input terminal (+) of the comparator 130, and the signal pwm output from the DUTYC 113 is input to an inverting input terminal (−) of the comparator 130. A signal outc output from the comparator 130 is input to an input terminal IN of the buffer circuit 150. A signal outcb, which is obtained by inverting the signal outc by an inverter circuit or the like, is input to an input terminal INB of the buffer circuit 150.

The output from the buffer circuit 150 is input to the gate of the transistor M1 as the signal GS (see FIG. 4).

The reference voltage VREFH of the hysteresis comparator 120 is higher than a voltage (VREF) of the signal FB, and the reference voltage VREFL is lower than the VREF. An “H” signal is output from the comparator 121 when the voltage of the FB exceeds the VREF. An “H” signal is output from the comparator 122 when the voltage of the FB is less than or equal to the VREF.

In the NAND gate circuits (123, 124), arithmetic operation is performed on a signal outcH output from the comparator 121 and a signal outcL output from the comparator 122. The output (Q, QB) from the NAND gate circuits (123, 124) is input to the buffer circuit 125. The output from the buffer circuit 125 is input to the logic unit 110 as the signal comp. Note that in the case where the buffer circuit 125 is not provided, output Q is input to the logic unit 110 as the signal comp generated in the hysteresis comparator 120.

### <Comparator CMP_A>

FIG. 9A is a block diagram illustrating an example of a configuration of the CMP_A, and FIG. 9B is a circuit diagram of the CMP_A.

The CMP_A includes input terminals to which voltages (VDD, VSS, IREF) are input, input terminals (VINP, VINN), and an output terminal CMPUT. The input terminal VINP is a non-inverting input terminal, and the input terminal VINN is an inverting input terminal.

The CMP_A includes a reference power source circuit 210, a differential amplifier circuit (AMPA) 211, a differential amplifier circuit (AMPB) 212, and an inverter circuit (INVA) 213. The AMPA 211 includes one or more stages, and the INVA 213 includes an even number of stages. Specific configurations of the circuits (210 to 213) will be described below.

### [Reference Power Source Circuit]

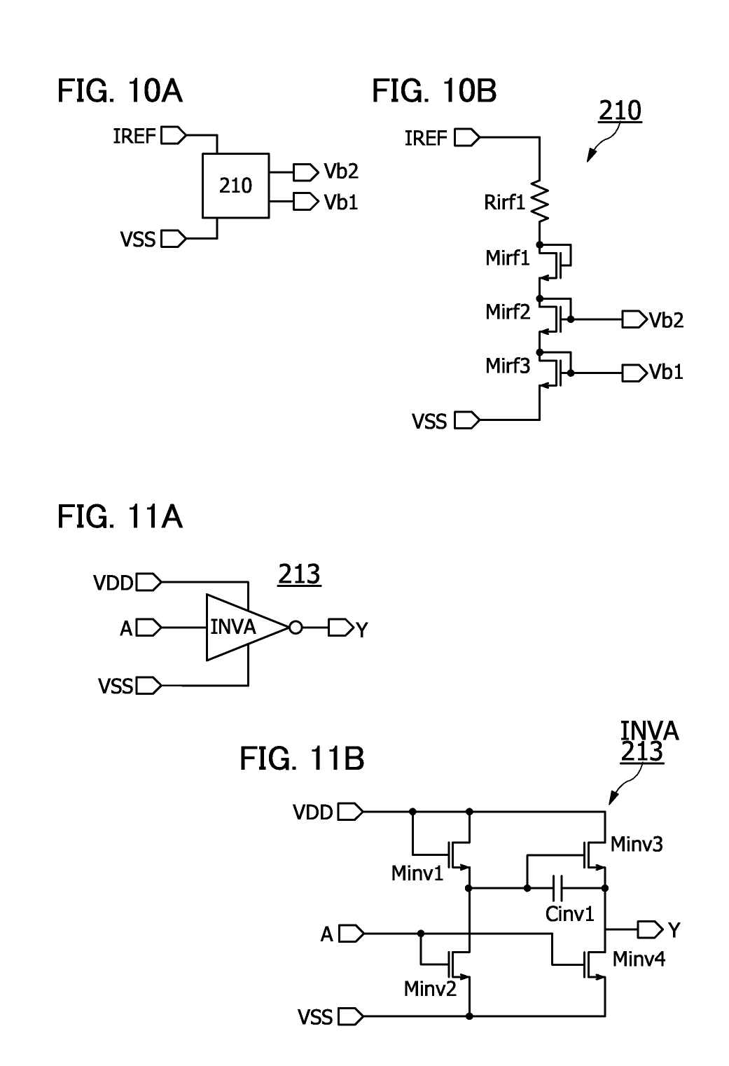

FIG. 10A is a block diagram illustrating an example of a configuration of the reference power source circuit 210, and FIG. 10B is a circuit diagram of the reference power source circuit 210.

The reference power source circuit 210 includes input terminals to which voltages (IREF, VSS) are input, and terminals (Vb1, Vb2) from which voltages generated therein are output. The reference power source circuit 210 can be constituted by a divider circuit. For example, as illustrated in FIG. 10B, the reference power source circuit 210 can be a divider circuit including a resistor Rirf1 and transistors (Mirf1, Mirf2, Mirf3).

### [INVA]

FIG. 11A is a block diagram illustrating an example of a configuration of the INVA 213, and FIG. 11B is a circuit diagram of the INVA 213.

The INVA 213 includes input terminals to which voltages (VDD, VSS) are input, an input terminal A, and an output terminal Y. The INVA 213 includes, for example, transistors (Minv1 to Minv4) and a capacitor Cinv1 as illustrated in FIG. 11B.

### [AMPA]

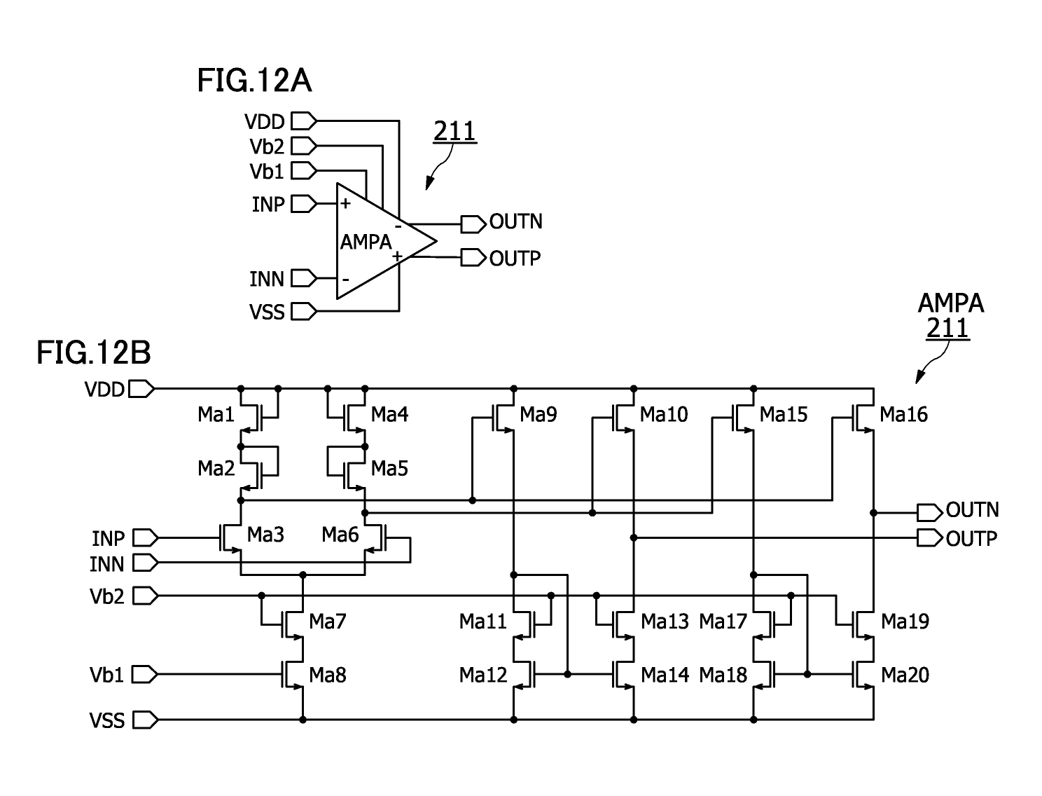

FIG. 12A is a block diagram illustrating an example of a configuration of the AMPA 211, and FIG. 12B is a circuit diagram of the AMPA 211.

The AMPA 211 includes input terminals to which voltages (VDD, VSS) are input, input terminals (Vb1, Vb2) to which a voltage is input from the reference power source circuit 210, input terminals (INP, INN), and output terminals (OUTP, OUTN). The terminal INP is a non-inverting input terminal and the terminal INN is an inverting input terminal. The terminal OUTP is a non-inverting output terminal and the terminal OUTN is an inverting output terminal. For example, the AMPA 211 includes transistors (Ma1 to Ma20) as illustrated in FIG. 12B.

### [AMPB]

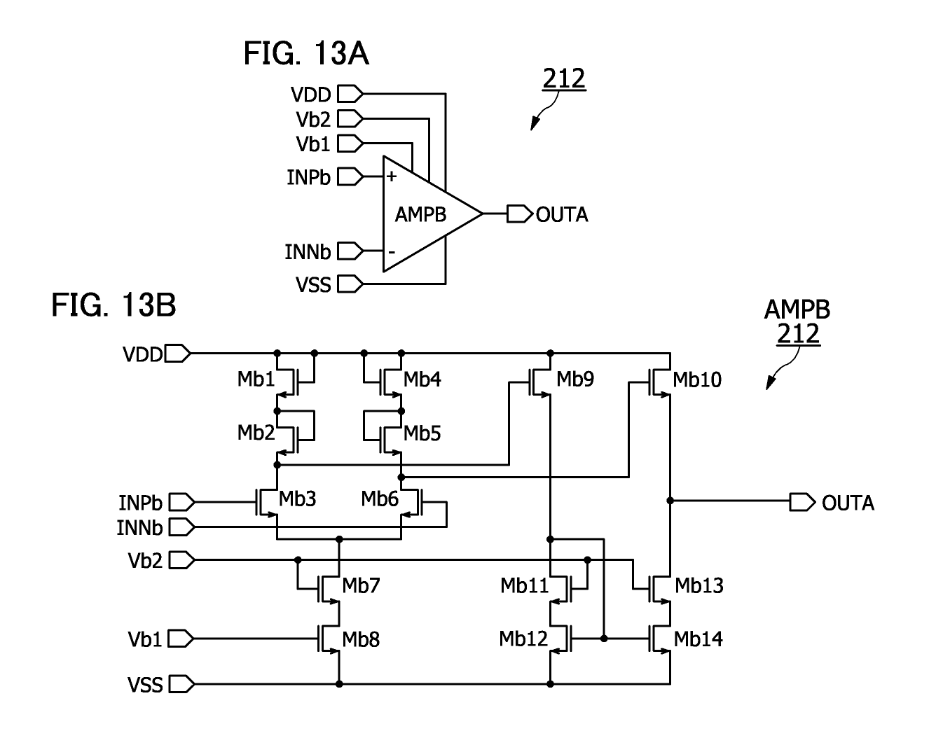

FIG. 13A is a block diagram illustrating an example of a configuration of the AMPB 212, and FIG. 13B is a circuit diagram of the AMPB 212.

The AMPB 212 includes input terminals to which voltages (VDD, VSS) are input, input terminals (Vb1, Vb2) to which a voltage is input from the reference power source circuit 210, input terminals (INP, INN), and an output terminal (OUTA). The terminal INP is a non-inverting input terminal and the terminal INN is an inverting input terminal. For example, the AMPB 212 includes transistors (Mb1 to Mb14) as illustrated in FIG. 13B.

### <NAND Gate Circuit>

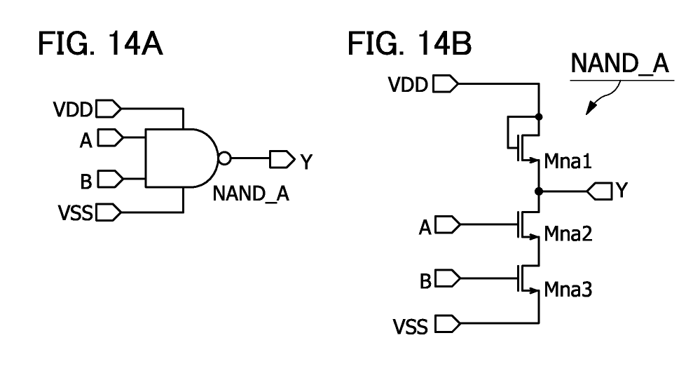

FIG. 14A is a block diagram illustrating an example of a configuration of the NAND_A included in the hysteresis comparator 120 (FIG. 8), and FIG. 14B is a circuit diagram of the NAND_A.

The NAND_A includes input terminals to which voltages (VDD, VSS) are input, input terminals (A, B), and an output terminal Y. The NAND_A includes, for example, transistors (Mna1 to Mna3) as illustrated in FIG. 14B.

### <Buffer Circuit (BUF_A)>

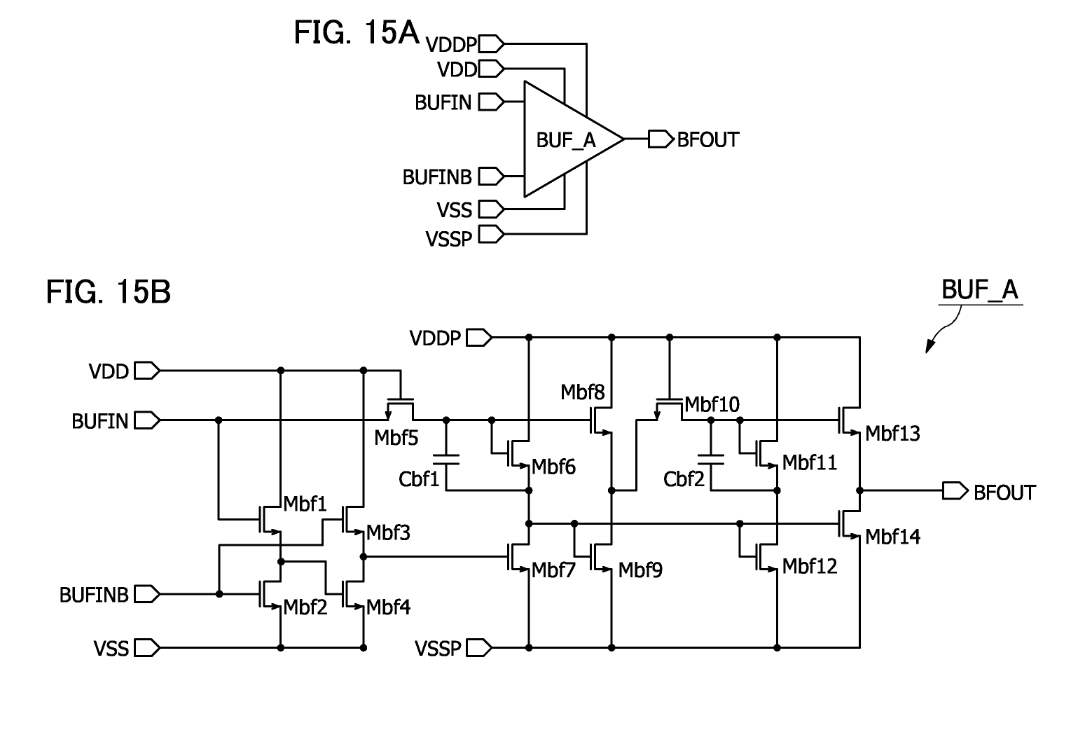

FIG. 15A is a block diagram illustrating an example of a configuration of the buffer circuit BUF_A included in the hysteresis comparator 120, and FIG. 15B is a circuit diagram of the buffer circuit BUF_A.

The BUF_A includes input terminals to which voltages (VDD, VSS, VDDP, VSSP) are input, input terminals (BUFIN, BUFINB), and an output terminal BUFOUT.

In the above manner, the circuits (120, 130, 140, 150) in the circuit block 200 in the logic unit 110 can be formed using transistors with the same conductivity (see FIG. 4). Moreover, the transistor M1 and the diode D1 can also be formed using transistors with the same conductivity. The diode D1 may be a diode-connected transistor.

When OS transistors are used for the logic unit 110, the transistor M1, and the diode D1, the obtained DC-DC converter can operate at a temperature higher than or equal to 150° C.

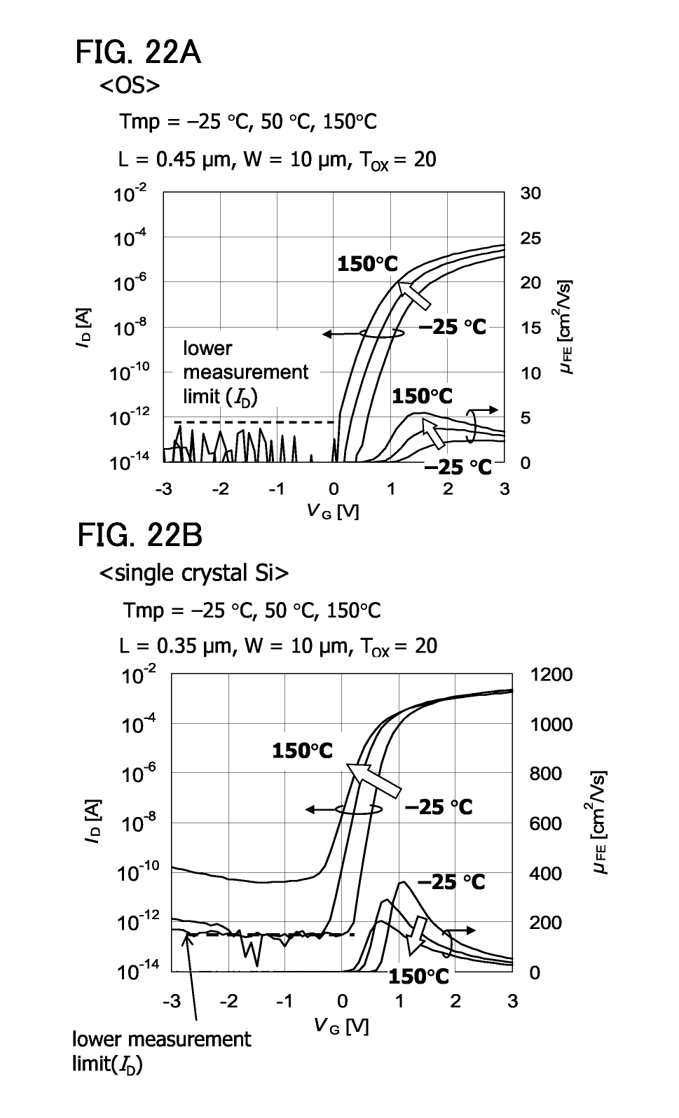

In conventional technologies, a control circuit for generating a signal GS (in this embodiment, a circuit corresponding to the logic unit 110) is constituted by Si transistors formed with a single crystal Si wafer. However, the measurement results of FIG. 22B indicate that a control circuit constituted by Si transistors cannot be used in an environment at a temperature higher than or equal to 150° C. An increase in the temperature of the control circuit is prevented by providing a large heat dissipation plate or the like; however, the heat dissipation plate leads to increased costs of the control circuit.

On the contrary, the measurement results of FIG. 22A indicate that a control circuit constituted by OS transistors can operate, without use of a large heat dissipation plate, in a wider range of temperature than the conventional control circuit using Si transistors. This results in lower costs of the control circuit.

The OS transistor will be described in Embodiment 2.

### <Example of Configuration of CTRL: 2>

In the logic unit 110, the duty ratio of the signal pwm decreases when the voltage of the signal FB is higher than the reference voltage, while the duty ratio of the signal pwm increases when the voltage of the signal FB is lower than the reference voltage. Accordingly, the signal pwm may be output to the gate of the transistor M1. Because the duty ratio of the signal pwm is determined depending on a change in the signal FB, the signal pwm can control the VOUT of the DC-DC converter 10. In such a case, the comparator 130, the DAC 140, and the like are not necessarily provided in the CTRL 100.

### <Example of Configuration of CTRL: 3>

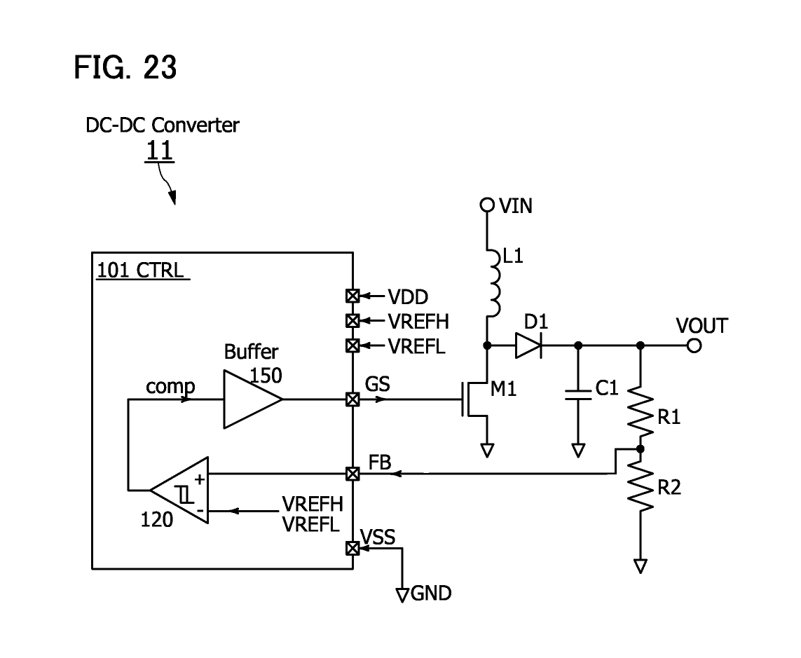

In the DC-DC converter 10 (FIG. 4), the signal comp output from the hysteresis comparator 120 can be used as a control signal for controlling on/off of the transistor M1. FIG. 23 illustrates an example of such a configuration of the DC-DC converter.

A DC-DC converter 11 illustrated in FIG. 23 is different from the DC-DC converter 10 in the configuration of the control circuit (CTRL). A control circuit (CTRL) 101 in the DC-DC converter 11 includes the hysteresis comparator 120 and the buffer circuit 150. The CTRL 101 is equivalent to a circuit in which the digital signal processing units (the logic unit 110, the DAC 140) are removed from the CTRL 100 in the DC-DC converter 10. Hence, the DC-DC converter 11 does not need to include the LPF 161 and the LPF 162.

The CTRL 101 includes the hysteresis comparator 120 and the buffer circuit 150. In other words, the CTRL 101 is a control circuit of a hysteresis control DC-DC converter while the CTRL 101 is a control circuit of a pulse-width modulation control DC-DC converter.

The logic unit 110 in the DC-DC converter 10 includes a digital signal processing unit; accordingly, the performance and function can be changed by changing a control signal (software) input from the outside, offering excellent expandability. The CTRL 101 in the DC-DC converter 11 includes the hysteresis comparator 120 and the buffer circuit 150, and thus achieves a high response rate and robust stability.

This embodiment can be implemented in appropriate combination with any of the other embodiments and example.

### Embodiment 2

In this embodiment, OS transistors will be described.

### <Example of Structure of Transistor: 1>

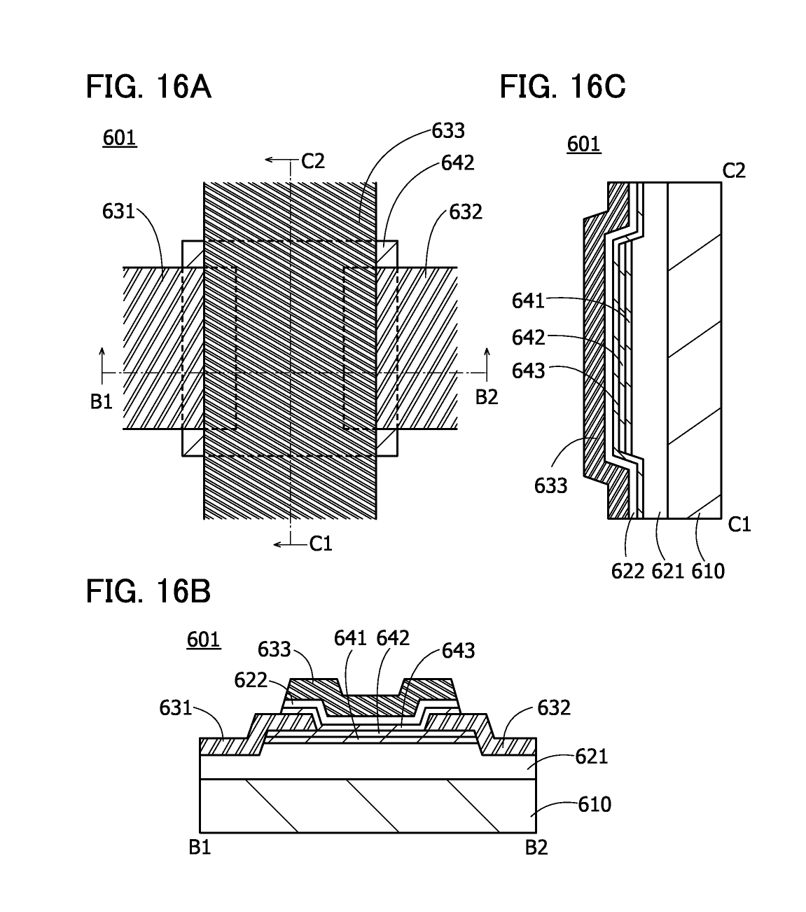

FIGS. 16A to 16C illustrate an example of a structure of an OS transistor. FIG. 16A is a top view, FIG. 16B is a cross-sectional view along line B1-B2 in FIG. 16A, and FIG. 16C is a cross-sectional view along ling C1-C2 in FIG. 16A.

As illustrated in FIGS. 16A to 16C, an OS transistor 601 includes an oxide semiconductor (OS) layer 641, an OS layer 642, an OS layer 643, a conductive layer 631, a conductive layer 632, a conductive layer 633, and an insulating layer 622.

A substrate 610 may be any substrate capable of withstanding the manufacturing process of the OS transistor 601. For example, a silicon wafer, a glass substrate, or a quartz substrate can be used. An insulating layer 621 is used as a base. The OS transistor 601 is formed over the insulating layer 621.

The conductive layers 631 and 632 serve as a source electrode or a drain electrode and are electrically connected to the OS layer 642. The conductive layer 633 is formed over the OS layers 641 to 643 with the insulating layer 622 interposed therebetween, and serves as a gate electrode. The insulating layer 622 is used as a gate insulating layer.

### <Example of Structure of Transistor: 2>

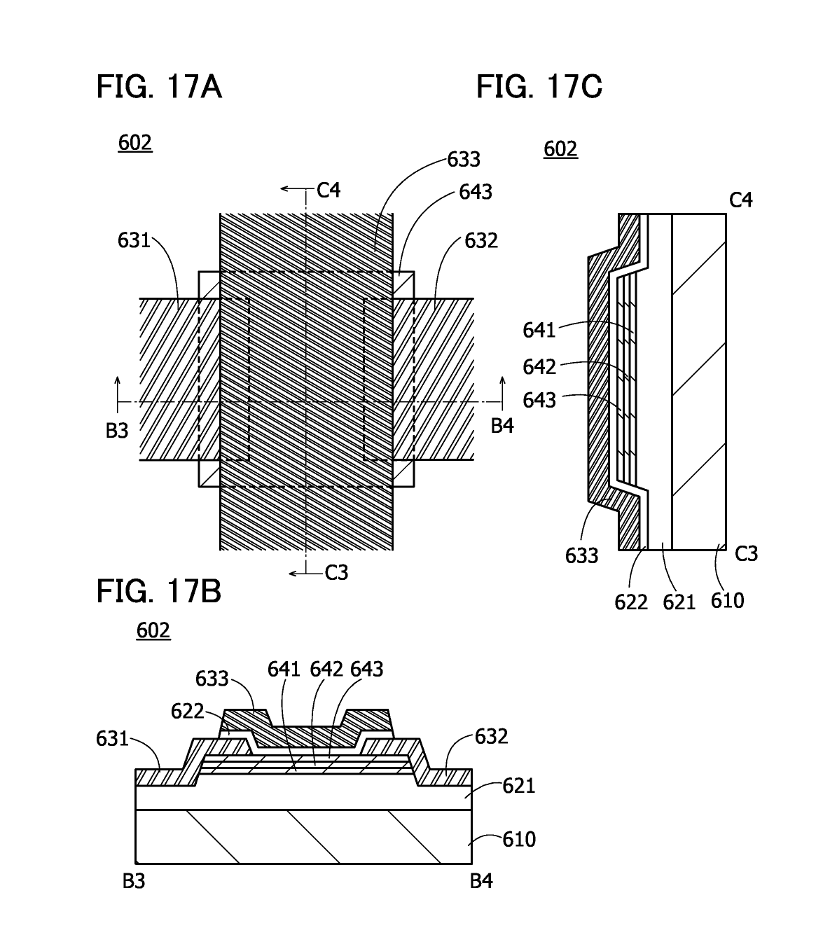

FIGS. 17A to 17C illustrate an example of a structure of an OS transistor. FIG. 17A is a top view, FIG. 17B is a cross-sectional view along line B3-B4 in FIG. 17A, and FIG. 17C is a cross-sectional view along ling C3-C4 in FIG. 17A.

Like the OS transistor 601, an OS transistor 602 illustrated in FIGS. 17A to 17C is formed over the insulating layer 621 and includes the OS layers 641 to 643, the conductive layers 631 to 633, and the insulating layer 622.

The OS transistor 602 is different from the OS transistor 601 in that the conductive layers 631 and 632 are formed over the OS layer 643.

FIGS. 16A to 16C and FIGS. 17A to 17C illustrate, but are not limited to, examples of using the stacked OS layers 641 to 643 as oxide semiconductor layers. For example, only one of the OS layers 641 and 642 may be provided in the OS transistor 601. The OS transistor 602 may also include one or two of the oxide semiconductor layers.

In the OS transistors 601 and 602, for example, at least the OS layer 642 of the OS layers 641 to 643 may include an In-M-Zn oxide (M is Ga, Y, Zr, La, Ce, or Nd), and the atomic ratio of In to M may differ depending on the usage of the OS transistors 601 and 602.

The OS layers 641 and 643 each contain at least one of the metal elements contained in the OS layer 642. The energy at the bottom of the conduction band of the OS layers 641 and 643 is closer to the vacuum level than that of the oxide layer 642 by 0.05 eV or more, 0.07 eV or more, or 0.1 eV or more, and 2 eV or less, 1 eV or less, 0.5 eV or less, or 0.4 eV or less.

Specifically, in the case where the OS layers 641 and 643 each contain an In-M-Zn oxide (M represents Ga, Y, Zr, La, Ce, or Nd) and a target having the atomic ratio of metal elements of In:M:Zn=x₃:y₃:z₃ is used for forming the OS layers 641 and 643, z₃/y₃ is preferably greater than or equal to ⅓ and less than or equal to 6, more preferably greater than or equal to 1 and less than or equal to 6. Note that when z₃/y₃ is greater than or equal to 1 and less than or equal to 6, a CAAC-OS film to be described later as the OS layers 641 and 643 is easily formed. Typical examples of the atomic ratio of the metal elements of the target are In:M:Zn=1:3:2, In:M:Zn=1:3:4, In:M:Zn=1:6:4, In:M:Zn=1:3:8, and the like. Note that the CAAC-OS is an oxide semiconductor having a c-axis aligned crystal part. The CAAC-OS will be described later. For example, in the case where a CAAC-OS film is deposited by a sputtering method, it is preferable to use a polycrystalline metal oxide target.

The thickness of each of the OS layers 641 and 643 is greater than or equal to 3 nm and less than or equal to 100 nm, preferably greater than or equal to 3 nm and less than or equal to 50 nm. The thickness of the OS layer 642 is greater than or equal to 3 nm and less than or equal to 200 nm, preferably greater than or equal to 3 nm and less than or equal to 100 nm, and more preferably greater than or equal to 3 nm and less than or equal to 50 nm.

Each of the OS layers 641 to 643 can be amorphous or crystalline. Note that the OS layer 642 in which a channel region is formed is preferably crystalline, in which case the OS transistors 601 and 602 can have stable electrical characteristics.

Note that a “channel formation region” refers to a region of a semiconductor layer of a transistor that overlaps with a gate electrode and is located between a source electrode and a drain electrode. A “channel region” refers to a region through which current mainly flows in the channel formation region.

In the case of the OS transistors 601 and 602, when a voltage is applied to the gate, a channel region is formed in the OS layer 642 having a small energy at the bottom of the conduction band. That is, because the OS layer 643 is provided between the OS layer 642 and the insulating layer 622, a channel region can be formed in the OS layer 642 which is insulated from the gate insulating layer 622.

The OS layer 643 contains at least one of the metal elements contained in the OS layer 642; thus, interface scattering is unlikely to occur at the interface between the OS layer 642 and the OS layer 643. Thus, the movement of carriers is unlikely to be inhibited at the interface, resulting in an increase in the field-effect mobility of the OS transistors 601 and 602.

When an interface level is formed at the interface between the OS layer 642 and the OS layer 641, a channel region is formed also in the vicinity of the interface, which causes a change in the threshold voltage of the OS transistors 601 and 602. However, since the OS layer 641 contains at least one of the metal elements contained in the OS layer 642, an interface level is unlikely to be formed at the interface between the OS layer 642 and the OS layer 641. Accordingly, the above structure can reduce variations in the electrical characteristics of the OS transistors 601 and 602, such as the threshold voltage.

Furthermore, a plurality of oxide semiconductor films are preferably stacked so that an interface level that inhibits carrier flow is not formed at the interface between the oxide semiconductor films due to an impurity existing between the metal oxide films. This is because when an impurity exists between the stacked metal oxide films, the continuity of the lowest conduction band energy between the metal oxide films is lost, and carriers are trapped or disappear by recombination in the vicinity of the interface. By reducing an impurity existing between the metal oxide films, a continuous junction (here, particularly a U-shape well structure where energy at the bottom of the conduction band is changed continuously between the films) is formed more easily than the case of merely stacking a plurality of metal oxide films that contain at least one common metal as a main component.

In order to form such a continuous junction, the films need to be stacked successively without being exposed to the air by using a multi-chamber deposition system (sputtering system) provided with a load lock chamber. Each chamber of the sputtering apparatus is preferably evacuated to a high vacuum (to approximately 5×10⁻⁷ Pa to 1×10⁻⁴ Pa) by an adsorption vacuum pump such as a cryopump so that water and the like acting as impurities for the oxide semiconductor are removed as much as possible. Alternatively, a turbo molecular pump and a cold trap are preferably used in combination to prevent backflow of gas into the chamber through an evacuation system.

To obtain a highly purified intrinsic oxide semiconductor, not only high vacuum evacuation of the chambers but also high purification of a gas used in the sputtering is important. When an oxygen gas or an argon gas used as the sputtering gas has a dew point of −40° C. or lower, preferably −80° C. or lower, and more preferably −100° C. or lower and is highly purified, moisture and the like can be prevented from entering the oxide semiconductor film as much as possible.

Note that the semiconductor film in the OS transistors 601 and 602 may have an end portion inclined or rounded.

In the OS transistors 601 and 602, a metal in the source and drain electrodes might extract oxygen from the oxide semiconductor film depending on a conductive material used for the source and drain electrodes. In such a case, regions of the oxide semiconductor film in contact with the source and drain electrodes become n-type regions because of the formation of an oxygen vacancy. The n-type regions serve as source and drain regions, resulting in a decrease in the contact resistance between the oxide semiconductor film and the source and drain electrodes. Accordingly, the formation of the n-type regions increases the mobility and the on-state current of the transistor, which achieves high-speed operation of a semiconductor device using the transistor.

Note that the extraction of oxygen by a metal in the source and drain electrodes is probably caused when the source and drain electrodes are formed by a sputtering method or when heat treatment is performed after the formation of the source and drain electrodes. The n-type regions are more likely to be formed when the source and drain electrodes are formed using a conductive material that is easily bonded to oxygen. Examples of such a conductive material include Al, Cr, Cu, Ta, Ti, Mo, and W.

The insulating layer 621 preferably contains oxygen at a proportion higher than or equal to the stoichiometric composition and has a function of supplying part of oxygen to the OS layers 641 to 643 by heating. In addition, the insulating layer 621 preferably has a few defects, typically, the spin density of a signal that appears at g=2.001 due to a dangling bond of silicon is lower than or equal to 1×10¹⁸ spins/cm³ when measured by electron spin resonance (ESR).

The insulating layer 621 has a function of supplying part of oxygen to the OS layers 641 to 643 by heating, and thus is preferably an oxide layer. Examples of the oxide include aluminum oxide, magnesium oxide, silicon oxide, silicon oxynitride, silicon nitride oxide, gallium oxide, germanium oxide, yttrium oxide, zirconium oxide, lanthanum oxide, neodymium oxide, hafnium oxide, and tantalum oxide. The insulating layer 621 can be formed by a plasma CVD (chemical vapor deposition) method, a sputtering method, or the like.

Note that in this specification, oxynitride contains more oxygen than nitrogen, and nitride oxide contains more nitrogen than oxygen.

In the OS transistors 601 and 602, the conductive layer 633 overlaps with an end portion of the OS layer 642 including a channel region that does not overlap with the conductive layers 631 and 632, i.e., an end portion of the OS layer 642 that is in a region where the conductive layers 631 and 632 are not located. When the end portion of the OS layer 642 is exposed to plasma by etching for forming the end portion, a chlorine radical, a fluorine radical, or other radicals generated from an etching gas are easily bonded to a metal element contained in an oxide semiconductor. For this reason, in the end portion of the oxide semiconductor film, oxygen bonded to the metal element is easily eliminated, so that an oxygen vacancy is easily formed; thus, the oxide semiconductor film easily has n-type conductivity.

However, in the OS transistors 601 and 602, the conductive layer 633 overlaps with the end portion of the OS layer 642 that does not overlap with the conductive layers 631 and 632; therefore, an electric field applied to the end portion can be controlled by controlling the potential of the conductive layer 633. Consequently, current that flows between the conductive layer 631 and the conductive layer 632 through the end portion of the OS layer 642 can be controlled by the potential applied to the conductive layer 633. Such a transistor structure is referred to as a surrounded channel (S-channel) structure.

Specifically, in the S-channel structure, when a potential at which the OS transistors 601 and 602 are turned off is applied to the conductive layer 633, the off-state current that flows between the conductive layer 631 and the conductive layer 632 through the end portion can be reduced. For this reason, in the OS transistors 601 and 602, even when the distance between the conductive layer 631 and the conductive layer 632 in the end portion of the OS layer 642 is reduced as a result of reducing the channel length to obtain high on-state current, the OS transistors 601 and 602 can have low off-state current. Consequently, with the short channel length, the OS transistors 601 and 602 can have high on-state current when in an on state and low off-state current when in an off state.

Also specifically, in the S-channel structure, when a potential at which the OS transistors 601 and 602 are turned on is applied to the conductive layer 633, the current that flows between the conductive layer 631 and the conductive layer 632 through the end portion can be increased. This current contributes to an increase in the field-effect mobility and on-state current of the OS transistors 601 and 602. When the end portion of the OS layer 642 overlaps with the conductive layer 633, carriers flow not only at the interface between the OS layer 642 and the insulating layer 622 but also in a wide region of the OS layer 642, which results in an increase in the amount of carriers that move in the OS transistors 601 and 602. As a result, the on-state current of the OS transistors 601 and 602 is increased, and the field-effect mobility is increased to greater than or equal to 10 cm²/V·s or to greater than or equal to 20 cm²/V·s, for example. Note that here, the field-effect mobility is not an approximate value of the mobility as the physical property of the oxide semiconductor film but is an index of current drive capability and the apparent field-effect mobility of a saturation region of the transistor.

This embodiment can be implemented in appropriate combination with any of the other embodiments and example.

### Embodiment 3

Described in this embodiment is an oxide semiconductor film capable of being used for the OS transistor described in Embodiment 2.

An oxide semiconductor film used for a channel formation region of the OS transistor preferably contains at least indium (In) or zinc (Zn). In particular, In and Zn are preferably contained. A stabilizer for strongly bonding oxygen is preferably contained in addition to In and Zn. As a stabilizer, at least one of gallium (Ga), tin (Sn), zirconium (Zr), hafnium (Hf), and aluminum (Al) may be contained.

As another stabilizer, one or plural kinds of lanthanoid such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu) may be contained.

As the oxide semiconductor film used for the OS transistor, for example, any of the following oxides can be used: indium oxide, tin oxide, zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, and an In—Hf—Al—Zn-based oxide.

For example, an In—Ga—Zn-based oxide with an atomic ratio of In:Ga:Zn=1:1:1, In:Ga:Zn=3:1:2, or In:Ga:Zn=2:1:3, or an oxide with an atomic ratio close to the above atomic ratios can be used.

If an oxide semiconductor film used for a channel formation region contains a large amount of hydrogen, the hydrogen and the oxide semiconductor are bonded to each other, so that part of the hydrogen serves as a donor and causes generation of an electron which is a carrier. As a result, the threshold voltage of the transistor shifts in the negative direction. It is therefore preferable that after the formation of the oxide semiconductor film, dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Therefore, it is preferable that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment, or treatment for making the oxygen content of an oxide semiconductor film be in excess of that in the stoichiometric composition may be expressed as treatment for making an oxygen-excess state.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) oxide semiconductor film or a substantially i-type (intrinsic) oxide semiconductor film which is extremely close to an i-type oxide semiconductor film. Note that “substantially intrinsic” means that the oxide semiconductor film contains extremely few (close to zero) carriers derived from a donor and has a carrier density of lower than or equal to 1×10¹⁷/cm³, lower than or equal to 1×10¹⁶/cm³, lower than or equal to 1×10¹⁵/cm³, lower than or equal to 1×10¹⁴/cm³, or lower than or equal to 1×10¹³/cm³.

The transistor including an i-type or substantially i-type oxide semiconductor film can have extremely favorable off-state current characteristics. For example, the off-state drain current of the transistor including the oxide semiconductor film can be 1×10⁻¹⁸ A or less, preferably 1×10⁻²¹ A or less, and more preferably 1×10⁻²⁴ A or less at room temperature (approximately 25° C.), or 1×10⁻¹⁵ A or less, preferably 1×10⁻¹⁸ A or less, and more preferably 1×10⁻²¹ A or less at 85° C. The off state of a transistor refers to a state where a gate voltage is much lower than the threshold voltage in the case of an n-channel transistor. Specifically, the transistor is in an off state when the gate voltage is lower than the threshold voltage by 1 V or more, 2 V or more, or 3 V or more.

An oxide semiconductor film is classified roughly into a non-single-crystal oxide semiconductor film and a single-crystal oxide semiconductor film. The non-single-crystal oxide semiconductor film includes any of a c-axis aligned crystalline oxide semiconductor (CAAC-OS) film, a polycrystalline oxide semiconductor film, a microcrystalline oxide semiconductor film, an amorphous oxide semiconductor film, and the like. An oxide semiconductor which is to be formed may include a non-single-crystal, for example. The non-single-crystal is, for example, structured by at least one of c-axis aligned crystal (CAAC), polycrystal, microcrystal, and an amorphous part.

### <CAAC-OS>

The CAAC-OS film is one of oxide semiconductor films having a plurality of c-axis aligned crystal parts. When a combined analysis image (also referred to as a high-resolution TEM image) of a bright-field image and a diffraction pattern of the CAAC-OS film is observed by a transmission electron microscope (TEM), a plurality of crystal parts is seen. However, in the high-resolution TEM image, a boundary between crystal parts, that is, a grain boundary is not clearly observed. Thus, in the CAAC-OS film, a reduction in electron mobility due to the grain boundary is less likely to occur.

According to the high-resolution cross-sectional TEM image of the CAAC-OS film observed in a direction substantially parallel to the sample surface, metal atoms are arranged in a layered manner in the crystal parts. Each metal atom layer has a morphology reflected by a surface over which the CAAC-OS film is formed (hereinafter, a surface over which the CAAC-OS film is formed is referred to as a formation surface) or a top surface of the CAAC-OS film, and is arranged in parallel to the formation surface or the top surface of the CAAC-OS film. In the high-resolution planar TEM image of the CAAC-OS film observed in a direction substantially perpendicular to the sample surface, metal atoms arranged in a triangular or hexagonal configuration are seen in the crystal parts. However, there is no regularity of arrangement of metal atoms between different crystal parts.

In an electron diffraction pattern of the CAAC-OS film, spots (luminescent spots) having alignment are shown. For example, spots are observed in an electron diffraction pattern (also referred to as a nanobeam electron diffraction pattern) of the top surface of the CAAC-OS film which is obtained using an electron beam with a diameter of, for example, larger than or equal to 1 nm and smaller than or equal to 30 nm.

From the results of the high-resolution cross-sectional TEM image and the high-resolution plan TEM image, alignment can be observed in the crystal parts in the CAAC-OS film.

Most of the crystal parts included in the CAAC-OS film each fit inside a cube whose one side is less than 100 nm. Thus, there is a case where a crystal part included in the CAAC-OS film fits inside a cube whose one side is less than 10 nm, less than 5 nm, or less than 3 nm. Note that when a plurality of crystal parts included in the CAAC-OS film are connected to each other, one large crystal region is formed in some cases. For example, a crystal region with an area of 2500 nm or more, 5 μm² or more, or 1000 μm² or more is observed in some cases in the plan high-resolution TEM image.

A CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

When the CAAC-OS film is analyzed by an in-plane method in which an X-ray enters a sample in a direction substantially perpendicular to the c-axis, a peak appears frequently when 2θ is around 56°. This peak is derived from the (110) plane of the InGaZnO₄ crystal. Here, analysis (φ scan) is performed under conditions where the sample is rotated around a normal vector of a sample surface as an axis (φ axis) with 2θ fixed at around 56°. In the case where the sample is a single-crystal oxide semiconductor film of InGaZnO₄, six peaks appear. The six peaks are derived from crystal planes equivalent to the (110) plane. On the other hand, in the case of a CAAC-OS film, a peak is not clearly observed even when 0 scan is performed with 2θ fixed at around 56°.

According to the above results, in the CAAC-OS film having c-axis alignment, while the directions of a-axes and b-axes are different between crystal parts, the c-axes are aligned in a direction parallel to a normal vector of a formation surface or a normal vector of a top surface. Thus, each metal atom layer arranged in a layered manner observed in the high-resolution cross-sectional TEM image corresponds to a plane parallel to the a-b plane of the crystal.

Note that the crystal part is formed concurrently with deposition of the CAAC-OS film or is formed through crystallization treatment such as heat treatment. As described above, the c-axis of the crystal is aligned in a direction parallel to a normal vector of a formation surface or a normal vector of a top surface of the CAAC-OS film. Thus, for example, in the case where the shape of the CAAC-OS film is changed by etching or the like, the c-axis might not be necessarily parallel to a normal vector of a formation surface or a normal vector of a top surface of the CAAC-OS film.

The distribution of c-axis aligned crystal parts in the CAAC-OS film is not necessarily uniform. For example, in the case where crystal growth leading to the crystal parts of the CAAC-OS film occurs from the vicinity of the top surface of the film, the proportion of the c-axis aligned crystal parts in the vicinity of the top surface is higher than that in the vicinity of the formation surface in some cases. Furthermore, when an impurity is added to the CAAC-OS film, a region to which the impurity is added is altered, and the proportion of the c-axis aligned crystal parts in the CAAC-OS film varies depending on regions, in some cases.

Note that when the CAAC-OS film with an InGaZnO₄ crystal is analyzed by an out-of-plane method, a peak of 2θ may also be observed at around 36°, in addition to the peak of 20 at around 31°. The peak of 20 at around 36° indicates that a crystal having no c-axis alignment is included in part of the CAAC-OS film. It is preferable that in the CAAC-OS film, a peak of 2θ appear at around 31° and a peak of 2θ do not appear at around 36°.

In this specification, a term “parallel” indicates that the angle formed between two straight lines is greater than or equal to −10° and less than or equal to 10°, and accordingly also includes the case where the angle is greater than or equal to −5° and less than or equal to 5°. In addition, a term “perpendicular” indicates that the angle formed between two straight lines is greater than or equal to 80° and less than or equal to 100°, and accordingly includes the case where the angle is greater than or equal to 85° and less than or equal to 95°.

The CAAC-OS film is an oxide semiconductor film having a low impurity concentration. The impurity is an element other than the main components of the oxide semiconductor film, such as hydrogen, carbon, silicon, or a transition metal element. In particular, an element that has higher bonding strength to oxygen than a metal element included in the oxide semiconductor film, such as silicon, disturbs the atomic arrangement of the oxide semiconductor film by depriving the oxide semiconductor film of oxygen and causes a decrease in crystallinity. Furthermore, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source.

The CAAC-OS film is an oxide semiconductor film having a low density of defect states. In some cases, oxygen vacancies in the oxide semiconductor film serve as carrier traps or serve as carrier generation sources when hydrogen is captured therein.

The CAAC-OS can also be formed by reducing the density of defect states for example. In an oxide semiconductor, for example, oxygen vacancies are defect states. The oxygen vacancies serve as trap levels or serve as carrier generation sources when hydrogen is trapped therein. In order to form the CAAC-OS, for example, it is important to prevent oxygen vacancies from being generated in the oxide semiconductor.

The state in which impurity concentration is low and density of defect states is low (the number of oxygen vacancies is small) is referred to as “highly purified intrinsic” or “substantially highly purified intrinsic”. A highly purified intrinsic or substantially highly purified intrinsic oxide semiconductor has few carrier generation sources, and thus has a low carrier density in some cases. Thus, in some cases, a transistor including the oxide semiconductor in a channel formation region rarely has a negative threshold voltage (is rarely normally-on). A highly purified intrinsic or substantially highly purified intrinsic oxide semiconductor has a low density of defect states and accordingly has a low density of trap states in some cases. Thus, the transistor including the oxide semiconductor in the channel formation region has a small variation in electrical characteristics and high reliability in some cases. A charge trapped by the trap states in the oxide semiconductor takes a long time to disappear and may behave like a fixed charge. Thus, the transistor which includes the oxide semiconductor having a high density of trap states in the channel formation region has unstable electrical characteristics in some cases.

Thus, with the use of the CAAC-OS in a transistor, change in electric characteristics of the transistor due to irradiation with visible light or ultraviolet light is small.

<nc-OS>

A microcrystalline oxide semiconductor has a region in which a crystal part is observed and a region in which a crystal part is not observed clearly in a high-resolution TEM image. In most cases, the size of a crystal part included in the microcrystalline oxide semiconductor is greater than or equal to 1 nm and less than or equal to 100 nm, or greater than or equal to 1 nm and less than or equal to 10 nm, for example. A microcrystal with a size greater than or equal to 1 nm and less than or equal to 10 nm, or a size greater than or equal to 1 nm and less than or equal to 3 nm is specifically referred to as nanocrystal (nc). An oxide semiconductor including nanocrystal is referred to as an nc-OS (nanocrystalline oxide semiconductor).

In a high-resolution TEM image of the nc-OS film, a crystal grain cannot be clearly observed sometimes. In the nc-OS film, a microscopic region (for example, a region with a size greater than or equal to 1 nm and less than or equal to 10 nm, in particular, a region with a size greater than or equal to 1 nm and less than or equal to 3 nm) has a periodic atomic order. Note that there is no regularity of crystal orientation between different crystal parts in the nc-OS film. Thus, the orientation of the whole film is not observed. Accordingly, in some cases, the nc-OS film cannot be distinguished from an amorphous oxide semiconductor film depending on an analysis method. For example, when the nc-OS film is subjected to structural analysis by an out-of-plane method with an XRD apparatus using an X-ray having a diameter larger than that of a crystal part, a peak which shows a crystal plane does not appear. Furthermore, a halo pattern is observed in an electron diffraction pattern (also referred to as a selected-area electron diffraction pattern) of the nc-OS film obtained by using an electron beam having a probe diameter (e.g., larger than or equal to 50 nm) larger than the diameter of a crystal part. Meanwhile, spots are shown in a nanobeam electron diffraction pattern of the nc-OS film obtained by using an electron beam having a probe diameter close to, or smaller than the diameter of a crystal part. Furthermore, in a nanobeam electron diffraction pattern of the nc-OS film, regions with high luminance in a circular (ring) pattern are shown in some cases. Also in a nanobeam electron diffraction pattern of the nc-OS film, a plurality of spots are shown in a ring-like region in some cases.

The nc-OS film is an oxide semiconductor film that has high regularity as compared to an amorphous oxide semiconductor film. Therefore, the nc-OS film has a lower density of defect states than an amorphous oxide semiconductor film. Note that there is no regularity of crystal orientation between different crystal parts in the nc-OS film. Therefore, the nc-OS film has a higher density of defect states than the CAAC-OS film.

### <Amorphous Oxide Semiconductor Film>

The amorphous oxide semiconductor film has disordered atomic arrangement and no crystal part. For example, the amorphous oxide semiconductor film does not have a specific state as in quartz.

In the high-resolution TEM image of the amorphous oxide semiconductor film, crystal parts cannot be found. When the amorphous oxide semiconductor film is subjected to structural analysis by an out-of-plane method with an XRD apparatus, a peak which shows a crystal plane does not appear. A halo pattern is shown in an electron diffraction pattern of the amorphous oxide semiconductor film. Furthermore, a halo pattern is shown but a spot is not shown in a nanobeam electron diffraction pattern of the amorphous oxide semiconductor film.

Note that an oxide semiconductor film may have a structure having physical properties between the nc-OS film and the amorphous oxide semiconductor film. The oxide semiconductor film having such a structure is specifically referred to as an amorphous-like oxide semiconductor (amorphous-like OS) film.

In a high-resolution TEM image of the amorphous-like OS film, a void may be seen. Furthermore, in the high-resolution TEM image, there are a region where a crystal part is clearly observed and a region where a crystal part is not observed. In the amorphous-like OS film, crystallization by a slight amount of electron beam used for TEM observation occurs and growth of the crystal part is found sometimes. In contrast, crystallization by a slight amount of electron beam used for TEM observation is less observed in the nc-OS film having good quality.

Note that the crystal part size in the amorphous-like OS film and the nc-OS film can be measured using high-resolution TEM images. For example, an InGaZnO₄ crystal has a layered structure in which two Ga—Zn—O layers are included between In—O layers. A unit cell of the InGaZnO₄ crystal has a structure in which nine layers of three In—O layers and six Ga—Zn—O layers are layered in the c-axis direction. Accordingly, the spacing between these adjacent layers is equivalent to the lattice spacing on the (009) plane (also referred to as d value). The value is calculated to 0.29 nm from crystal structure analysis. Thus, each of the lattice fringes in which the spacing therebetween is from 0.28 nm to 0.30 nm corresponds to the a-b plane of the InGaZnO₄ crystal, focusing on the lattice fringes in the high-resolution TEM image.

An oxide semiconductor film may be a stacked film including two or more films of an amorphous oxide semiconductor film, a microcrystalline oxide semiconductor film, and a CAAC-OS film, for example. Note that the oxide semiconductor film may be a mixed film including two or more of a CAAC-OS, a polycrystalline oxide semiconductor, a microcrystalline oxide semiconductor, and an amorphous oxide semiconductor. In the case where the oxide semiconductor film has a plurality of structures, for example, the structures can be analyzed using nanobeam electron diffraction in some cases.

This embodiment can be implemented in appropriate combination with any of the other embodiments and example.

### Embodiment 4

In this embodiment, examples of electronic appliances each including the DC-DC converter described in the above embodiments will be described as examples of the semiconductor device.

The DC-DC converter of one embodiment of the present invention can be used for a variety of electronic devices including circuits, devices and the like driven by a DC voltage.

Specific examples of electronic devices are as follows: display devices of televisions, monitors, and the like, lighting devices, desktop personal computers and laptop personal computers, word processors, image reproduction devices which reproduce still images or moving images stored in recording media such as digital versatile discs (DVDs), portable or stationary music reproduction devices such as compact disc (CD) players and digital audio players, portable or stationary radio receivers, recording reproduction devices such as tape recorders and IC recorders (voice recorders), headphone stereos, stereos, clocks such as table clocks and wall clocks, cordless phone handsets, portable wireless devices, cellular phones, car phones, portable or stationary game machines, calculators, portable information terminals, electronic notebooks, e-book terminals, electronic translators, audio input devices such as microphones, cameras such as still cameras and video cameras, electric shavers, high-frequency heating appliances such as microwave ovens, electric rice cookers, electric washing machines, electric vacuum cleaners, water heaters, electric fans, hair dryers, air-conditioning systems such as humidifiers, dehumidifiers, and air conditioners, dishwashers, dish dryers, clothes dryers, futon dryers, electric refrigerators, electric freezers, electric refrigerator-freezers, freezers for preserving DNA, flashlights, electric power tools, smoke detectors, and health equipment and medical equipment such as hearing aids, cardiac pacemakers, portable X-ray equipments, electric massagers, dialyzers, and the like. Furthermore, industrial equipment such as guide lights, traffic lights, meters such as gas meters and water meters, belt conveyors, elevators, escalators, industrial robots, wireless relay stations, base stations of cell phones, power storage systems, and power storage devices for leveling the amount of power supply and smart grid can be given. In addition, moving objects and the like driven by electric motors using electric power from lithium-ion secondary batteries are also included in the category of electronic devices. Examples of the above moving objects include electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, agricultural machines, motorized bicycles including motor-assisted bicycles, motorcycles, electric wheelchairs, electric carts, boats, ships, submarines, aircrafts such as fixed-wing aircraft and rotary-wing aircraft, rockets, artificial satellites, space probes, rovers, and spacecrafts.

In one embodiment of the present invention, a DC-DC converter, particularly including a control circuit formed with OS transistors, can operate at a temperature of 150° C. or higher. Thus, such a DC-DC converter of the embodiment is preferably used for an electronic device that is likely to operate at high temperatures. Examples of these electronic device include electric vehicles (including hybrid electric vehicles and plug-in hybrid electric vehicles), power tools, industrial robots, smoke detectors, and uninterruptible power storages.

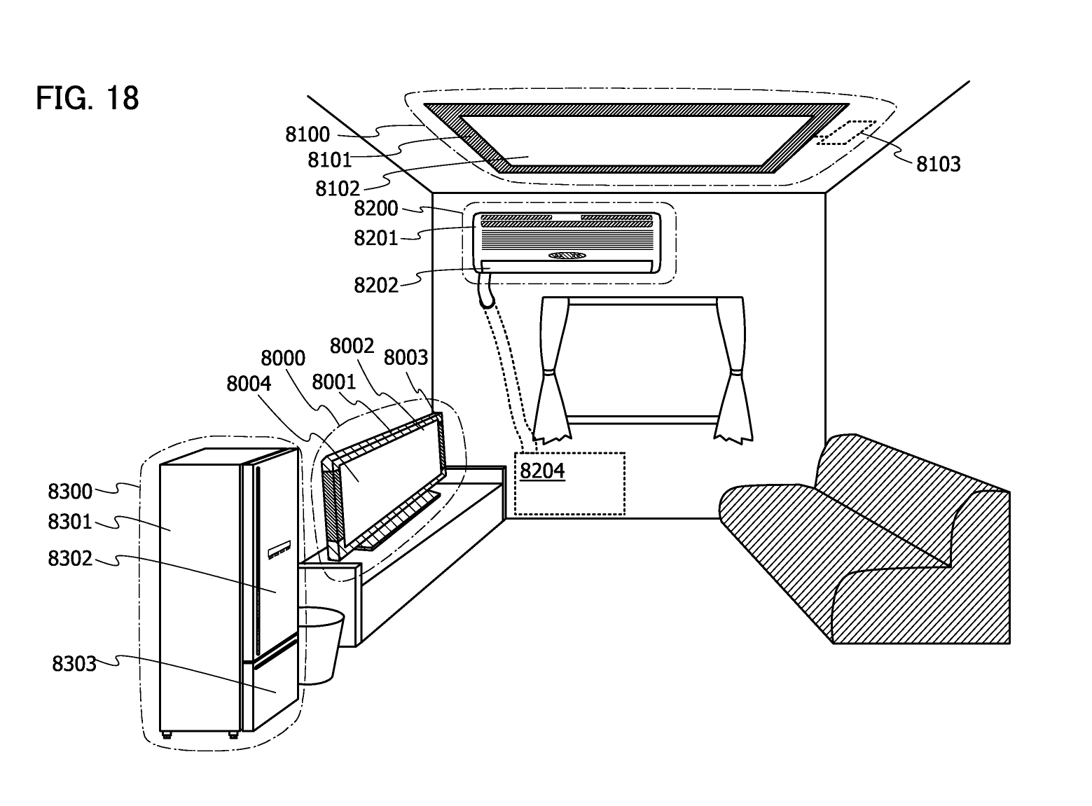

FIG. 18 illustrate specific examples of the electronic devices.

FIG. 18 illustrates an example of a display device. A display device 8000 corresponds to a display device for TV broadcast reception for example, and includes a housing 8001, a display portion 8002, speaker portions 8003, and the like. The DC-DC converter of one embodiment of the present invention is provided in the housing 8001.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device in this embodiment includes, in its category, all of information display devices for personal computers, advertisement displays, and the like other than TV broadcast reception.

FIG. 18 illustrates an example of an installation lighting device. A lighting device 8100 is provided on a ceiling. The lighting device 8100 includes a housing 8101, a light source 8102, a control device 8103, and the like. The control device 8103 is a semiconductor device that performs lightening control, timer control and the like. The DC-DC converter is incorporated in the control device 8103.

Although the installation lighting device 8100 for houses is illustrated in FIG. 18 as an example, the DC-DC converter of one embodiment of the present invention can also be used in a tabletop lighting device, an outdoor lighting device, and the like.

FIG. 18 illustrates an example of a split system air conditioner. The air conditioner includes an indoor unit 8200 and an outdoor unit 8204. The indoor unit 8200 includes a housing 8201, an air outlet 8202, and the like. The DC-DC converter of one embodiment of the present invention is provided in a power source circuit of the indoor unit 8200 and the outdoor unit 8204.

Note that FIG. 18 illustrates the split system air conditioner as an example; alternatively, an air conditioner may be such that the functions of an indoor unit and an outdoor unit are integrated in one housing.

FIG. 18 illustrates an electric refrigerator-freezer as an example of a home electric device. An electric refrigerator-freezer 8300 includes a housing 8301, a refrigerator door 8302, a freezer door 8303, and the like. The DC-DC converter of one embodiment of the present invention is provided in the housing 8301.

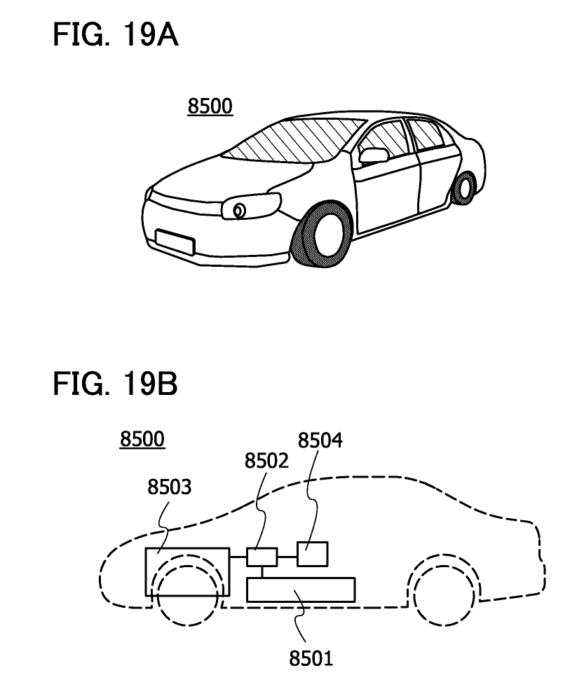

FIGS. 19A and 19B illustrate an example of an electric vehicle.

An electric vehicle 8500 is equipped with a lithium-ion secondary battery 8501. The output of the electric power of the lithium-ion secondary battery 8501 is adjusted by a control circuit 8502 and the electric power is supplied to a driving device 8503. The control circuit 8502 is controlled by a processing unit 8504 including a ROM, a RAM, a CPU, or the like which is not illustrated. For example, the DC-DC converter of one embodiment of the present invention is provided in the control circuit 8502 or a power source circuit of the processing unit 8504 and the like.

The driving device 8503 includes a DC motor or an AC motor either alone or in combination with an internal-combustion engine. The processing unit 8504 outputs a control signal to the control circuit 8502 based on input data such as data on operation (e.g., acceleration, deceleration, or stop) by a driver of the electric vehicle 8500 or data on driving the electric vehicle 8500 (e.g., data on an upgrade or a downgrade, or data on a load on a driving wheel). The control circuit 8502 adjusts the electric energy supplied from the lithium-ion secondary battery 8501 in accordance with the control signal of the processing unit 8504 to control the output of the driving device 8503.

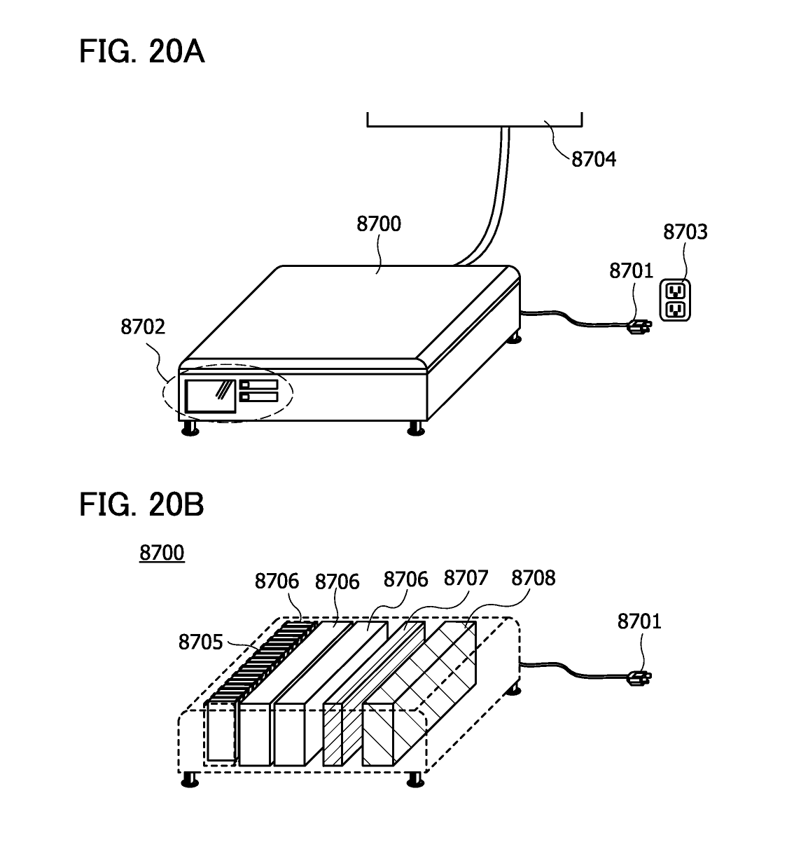

FIGS. 20A and 20B illustrate an example of a power storage device.

As illustrated in FIG. 20A, a power storage device 8700 includes a plug 8701 for being electrically connected to a system power supply 8703. Furthermore, the power storage device 8700 is electrically connected to a panelboard 8704 installed in home.

The power storage device 8700 may further include a display panel 8702 for displaying an operation state or the like, for example. The display panel may have a touch screen. In addition, a power storage device 8700 may include a switch for turning on and off a main power source, a switch to operate the power storage system, and the like as well as the display panel.

Although not illustrated, an operation switch to operate the power storage device 8700 may be provided separately from the power storage device 8700; for example, the operation switch may be provided on a wall in a room. Alternatively, the power storage device 8700 may be connected to a personal computer, a server, or the like provided in home, in order to be operated indirectly. Still alternatively, the power storage device 8700 may be remotely operated using the Internet, an information terminal such as a smartphone, or the like. In such cases, a mechanism that performs wired or wireless communication between the power storage device 8700 and other devices is provided in the power storage device 8700.

FIG. 20B is a schematic view illustrating the inside of the power storage device 8700. The power storage device 8700 includes battery groups 8706 each having a plurality of batteries 8705, a battery management unit (BMU) 8707, and a power conditioning system (PCS) 8708.

In each of the battery groups 8706, a plurality of batteries 8705 are connected to each other. Electric power from the system power supply 8703 can be stored in the battery groups 8706. The battery groups 8706 are each electrically connected to the BMU 8707.

The BMU 8707 has functions of monitoring and controlling the states of the plurality of batteries 8705 in each of the battery groups 8706 and protecting the batteries 8705. Specifically, the BMU 8707 collects data of cell voltages and cell temperatures of the plurality of batteries 8705 in each of the battery groups 8706, monitors overcharge and overdischarge, monitors overcurrent, controls a cell balancer, manages the degradation condition of a battery, calculates the remaining battery level (the state of charge (SOC)), controls a cooling fan, or controls detection of failure, for example. Note that the batteries 8705 may have some of or all the functions, or the battery groups 8706 may each have the functions. The BMU 8707 is electrically connected to the PCS 8708.

The PCS 8708 is electrically connected to the system power supply 8703 which is an AC power source and performs DC-AC conversion. For example, the PCS 8708 includes an inverter, a system interconnection protective device that detects irregularity of the system power supply 8703 and terminates its operation, and the like. In charging the power storage device 8700, for example, AC power from the system power supply 8703 is converted into DC power and transmitted to the BMU 8707. In discharging the power storage device 8700, electric power stored in the battery groups 8706 is converted into AC power and supplied to an indoor load, for example. Note that the electric power may be supplied from the power storage device 8700 to the load through the panelboard 8704 as illustrated in FIG. 20A or may be directly supplied from the power storage device 8700 through wired or wireless transmission.

The DC-DC converter of one embodiment of the present invention can be provided in a power source circuit of a circuit in which the PCS 8708 or the BMU 8707 is incorporated, for example.

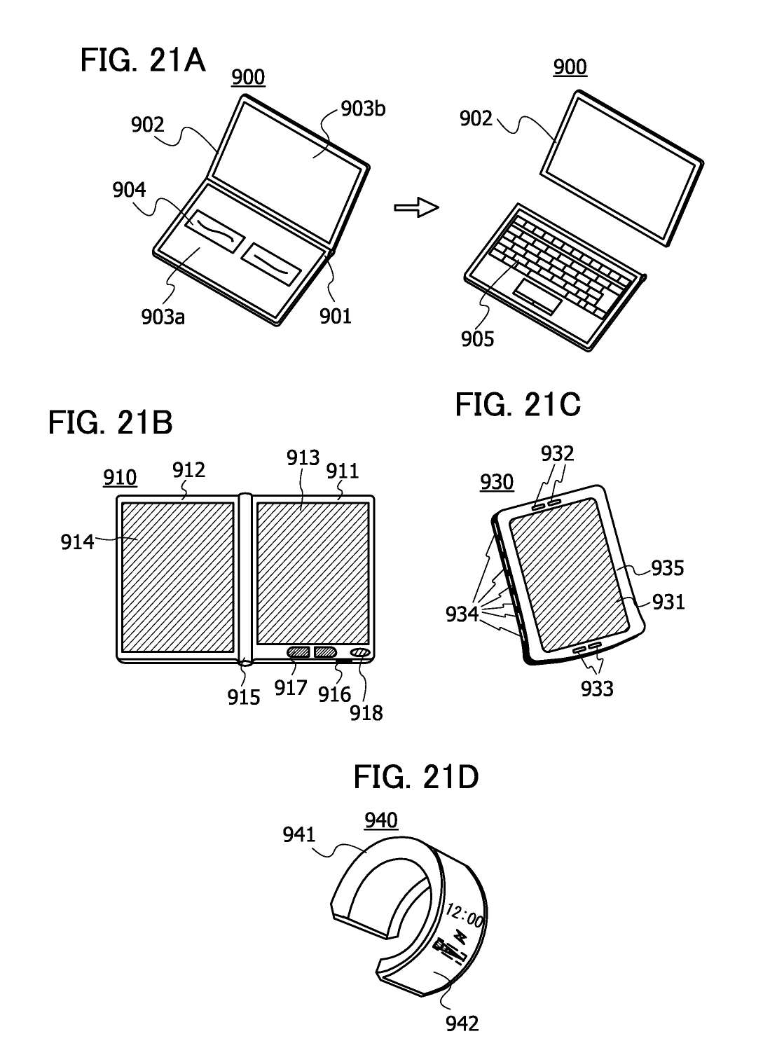

FIGS. 21A to 21D illustrate some specific examples of digital devices as electronic devices.

FIG. 21A illustrates an example of a portable information terminal. An information terminal 900 includes a housing 901, a housing 902, a display portion 903a, a display portion 903b, and the like. The DC-DC converter 10 is used for at least part of the housings 901 and 902.

Note that the display portion 903a is a touch panel, and for example, as illustrated in the left of FIG. 21A, which of “touch input” and “keyboard input” is performed can be selected by a selection button 904 displayed on the display portion 903a. Since the selection buttons with a variety of sizes can be displayed, the portable information terminal can be easily used by people of any generation. For example, when “keyboard input” is selected, a keyboard 905 is displayed on the display portion 903a as illustrated in the right of FIG. 21A. With such a structure, letters can be input quickly by keyboard input as in the case of using a conventional information terminal, for example.

One of the display portions 903a and 903b can be detached from the information terminal 900 as illustrated in the right of FIG. 21A. The display portion 903a can also function as a touch panel for a reduction in weight to carry around to be operated by one hand while the other hand supports the housing 902, which is convenient.

The information terminal 900 can have a function of displaying a variety of information (e.g., a still image, a moving image, and a text image); a function of displaying a calendar, a date, the time, or the like on the display portion; a function of operating or editing information displayed on the display portion; a function of controlling processing by various kinds of software (programs); and the like. Furthermore, an external connection terminal (an earphone terminal, a USB terminal, or the like), a recording medium insertion portion, and the like may be provided on the back or side surface of the housing.

The information terminal 900 may transmit and receive data wirelessly. Through wireless communication, desired book data or the like can be purchased and downloaded from an e-book server.

Furthermore, the housing 902 may have an antenna, a microphone function, or a wireless communication function to be used as a cellular phone.

FIG. 21B illustrates an example of a structure of an e-book reader 910 incorporating electronic paper. An e-book reader 910 includes two housings of a housing 911 and a housing 912. The housing 911 and the housing 912 are provided with a display portion 913 and a display portion 914, respectively. The housings 911 and 912 are connected to each other by a hinge 915, so that the e-book reader 910 can be opened and closed using the hinge 915 as an axis. The housing 911 is provided with a power switch 916, an operation key 917, a speaker 918, and the like. The DC-DC converter 10 is provided in at least one of the housings 911 and 912.

FIG. 21C illustrates an example of a structure of a smartphone. A main body 935 of a smartphone 930 is provided with a display portion 931, a speaker 932, a microphone 933, operation keys 934, and the like. The DC-DC converter 10 is provided in the main body 935.

FIG. 21D illustrates an example of a structure of a wristwatch type display device. A wristwatch type display device 940 includes a main body 941, a display portion 942, and the like. The DC-DC converter 10 is provided in the main body 941.

This embodiment can be implemented in appropriate combination with any of the other embodiments and example.

### Example 1

### Control Circuit of DC-DC Converter

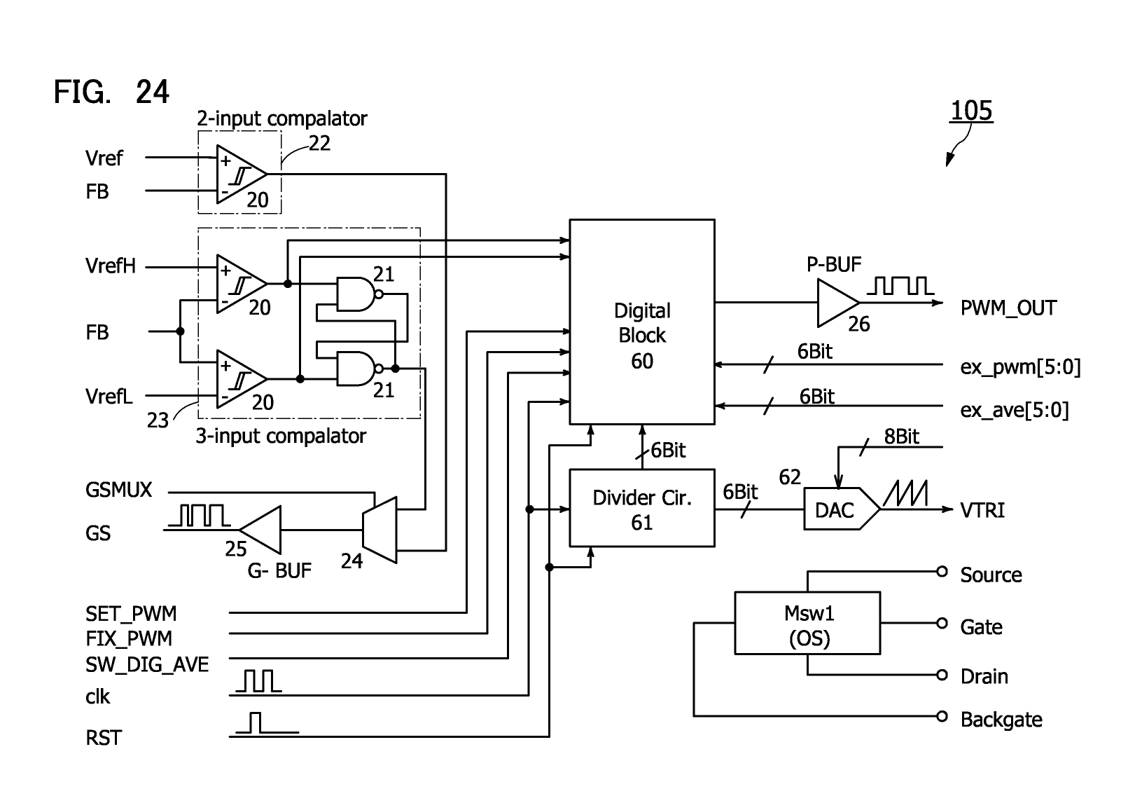

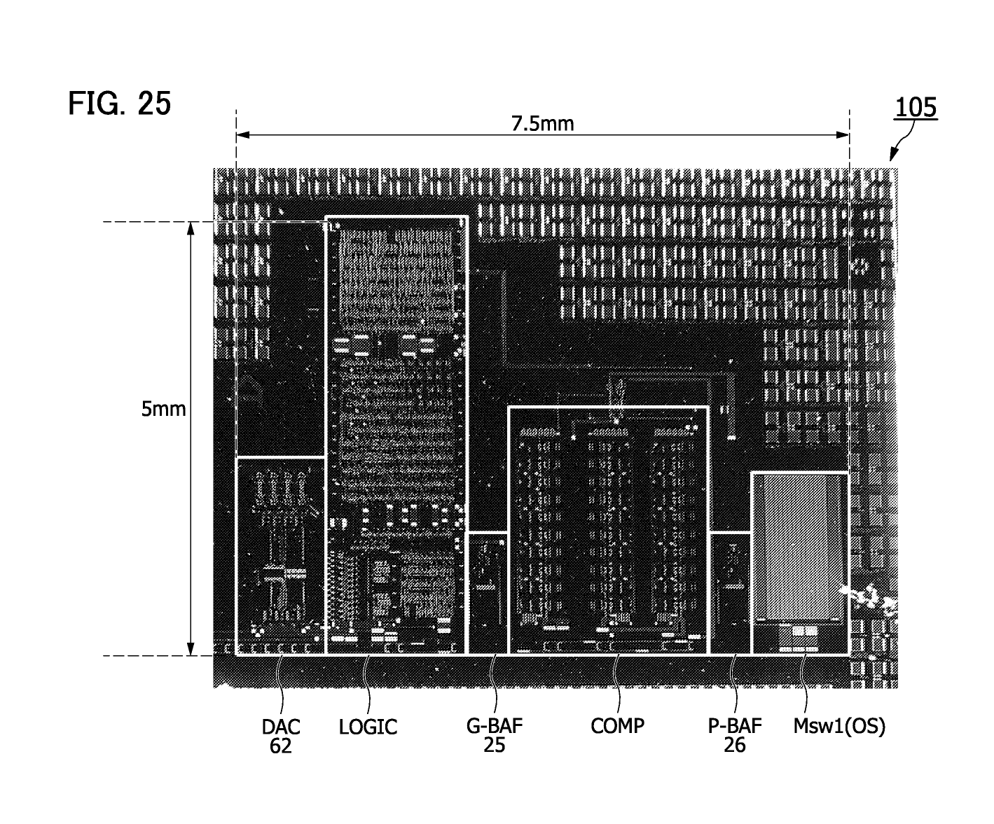

A designed control circuit of a DC-DC converter was fabricated using OS transistors (n-channel transistors) and the performance thereof was measured. Here, a circuit group equivalent to the circuit block 200 in FIG. 4 was fabricated as the control circuit. Furthermore, a switch of a voltage converter circuit was integrated on the same chip as the circuit group. FIG. 24 is a block diagram of the circuit group integrated on a chip and FIG. 25 is an optical micrograph of the chip.

As illustrated in FIG. 24, the switch of the voltage converter circuit includes an OS transistor Msw1 provided with a back-gate. The OS transistor Msw1 has a channel length of 3 μm and a channel width of 183,700 μm. Note that the OS transistor Msw1 is constituted by a plurality of OS transistors electrically connected in parallel to each other.

As illustrated in FIG. 24, in the control circuit 105, a control mode can be switched between a PWM control mode (hereinafter referred to as a PWM mode) and a hysteresis control mode (a hysteresis mode). The control circuit 105 includes a two-input comparator 22, a three-input comparator 23, a selector circuit 24, a buffer circuit (G-BUF) 25, a buffer circuit (P-BUF) 26, a digital block 60, a divider circuit 61, and a DAC 62. OS transistors are used for the control circuit 105 and the OS transistor Msw1. An oxide semiconductor layer in each OS transistor was formed using an oxide semiconductor film that was formed under the conditions where the CAAC-OS was able to be obtained.

In FIG. 25, a comparator unit (COMP) is a circuit block including three comparators 20 which constitute the two-input comparator 22 or the three-input comparator 23. A logic unit (LOGIC) is a circuit block including two NAND gate circuits 21, the selector circuit 24, the digital block 60, and the divider circuit 61. The control circuit 105 has a size of 5 mm×7.7 mm.

In the control circuit 105, a circuit group operating with the PWM mode includes the three-input comparator 23, the digital block 60, the divider circuit 61, the DAC 62, and the P-BUF 26. The configuration and performance of these circuits are similar to those of the logic unit 110 in FIG. 4, and thus the description of the logic unit 110 is referred to.

The divider circuit 61 is equivalent to the CLKDIV 111. The digital block 60 is a digital signal processing circuit having functions of the AVEC 112 and the DUTYC 113. The divider circuit 61 generates a 6-bit digital signal from a clock signal clk and outputs the digital signal to the digital block 60 and the DAC 62. The DAC 62 generates a signal VTRI in accordance with an 8-bit digital signal and outputs the signal VTRI. A digital signal processed in the digital block 60 is output to the P-BUF 26. In the PWM mode, a signal PWM_OUT output from the P-BUF 26 is used as a control signal of the switch of the voltage converter circuit.

A signal SET_PWM determines whether the DUTY ratio setting value of the signal PWM_OUT is set by an external input signal expwm [5:0] or a value calculated in the digital block 60. A signal FIX_PWM is a control signal for determining the initial value of the DUTY ratio setting value. A signal SW_DIG_AVE determines whether the average value of the values output from the three-input comparator 23 is set by an external input signal ex_ave[5:0] or a value calculated in the digital block 60.

In the hysteresis mode, a signal GS output from the G-BUF 25 is a control signal of the switch of the voltage converter circuit. The selector circuit 24 switches the signal output to the G-BUF 25 between the signal output from the two-input comparator 22 and the signal output from the three-input comparator 23 in accordance with a signal GSMUX. A voltage Vref is a reference voltage of the two-input comparator 22.

The two-input comparator 22 includes a comparator 20. The three-input comparator 23 has a circuit configuration similar to that of the hysteresis comparator 120 (FIG. 8), and includes two comparators 20 and two NAND gate circuits 21. The comparator 20 has a circuit configuration similar to that of the CMP_A (FIGS. 9A and 9B). Here, the comparator 20 includes the reference power source circuit 210 (FIGS. 10A and 10B), the 9-stage AMPA 211 (FIGS. 12A and 12B), the one-stage AMPB 212 (FIGS. 13A and 13B), and the 6-stage INVA 213 (11A and 11B). The 6-stage INVA 213 serves as a buffer circuit. The NAND gate circuit 21 has a circuit configuration similar to that of the NAND_A (FIGS. 14A and 14B).

In the case where a differential amplifier circuit is constituted by transistors with one conductivity type, it is not possible to make a cascode current mirror circuit which is a complementary combination of an n-channel transistor and a p-channel transistor. Therefore, as illustrated in FIGS. 12A and 12B and FIGS. 13A and 13B, a folded cascode circuit is used for the amplifier circuits (AMPA 211, AMPB 212) in the comparator 20. As a result, the operation voltage of the comparator 20 can be reduced. Moreover, many current mirror circuits are used for the AMPA 211 and the AMPB 212 to stabilize the current bias with a temperature change.

### <<Operation Verification Results of Comparator>>

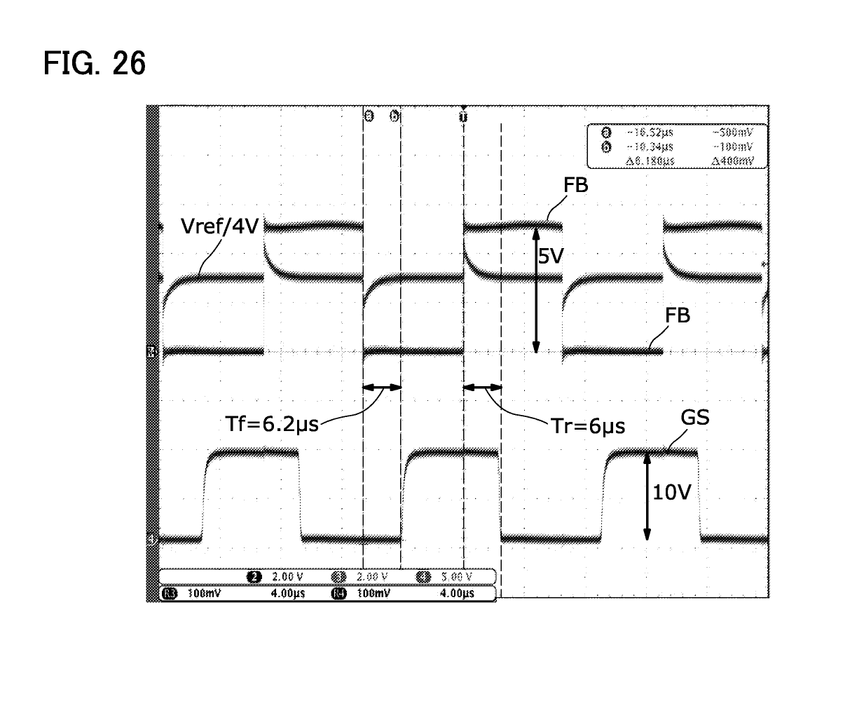

The operation of the two-input comparator 22 (comparator 20) was verified under a high temperature. The results are shown in FIG. 26. FIG. 26 shows the waveforms of the input signals (Vref, FB) of the two-input comparator 22 and the output signal GS, which were measured with an oscilloscope. The measurement was performed at 150° C. A reference voltage Vref of 4.0 V was input to the two-input comparator 22, and a clock signal with an amplitude of 5.0 V and a frequency of 35 kHz was input as a feedback signal FB. The amplitude of the signal GS was 10 V. The fall time Tf and the rise time Tr of the signal GS were 6.2 μs and 6 μs, respectively. FIG. 26 shows that the produced comparator 20 can operate at 150° C. with a frequency of 35 kHz.

### <<Operation Verification Results of DC-DC Converter>>

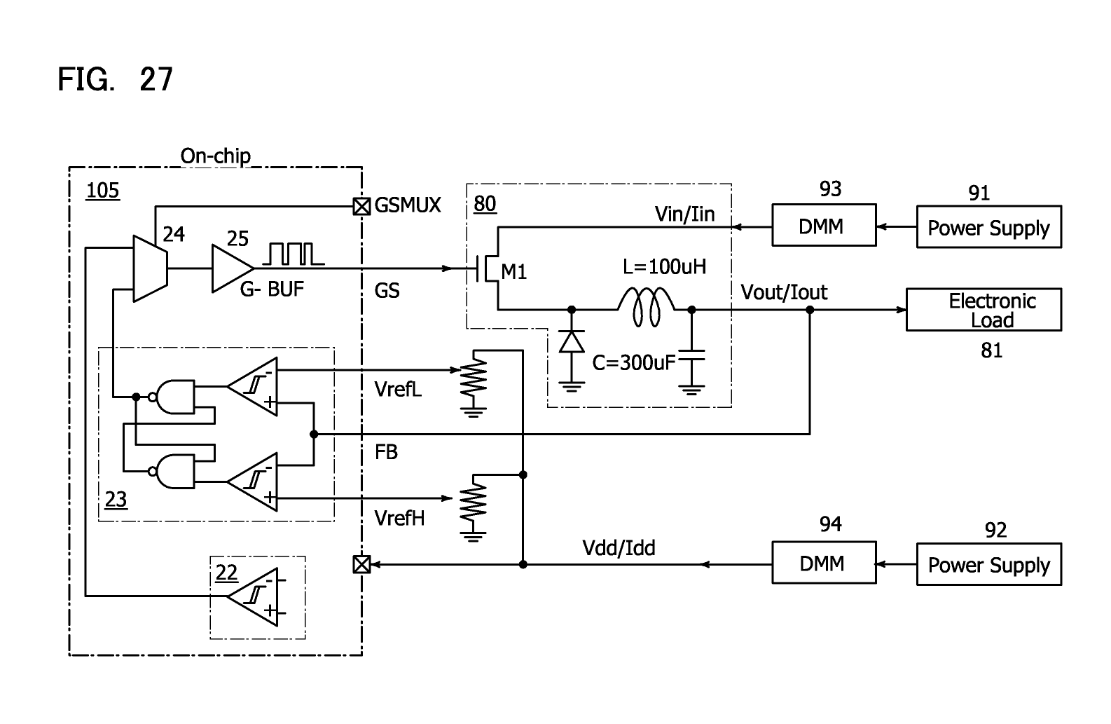

A DC-DC converter was produced by combining the control circuit 105 and a voltage converter circuit, and the power efficiency thereof was measured. FIG. 27 is a schematic view showing a method for measuring the power efficiency of the DC-DC converter.

The control circuit 105 was operated in a hysteresis mode. The three-input comparator 23 was used for a hysteresis comparator. A step-down chopper circuit was used for a voltage converter circuit 80. A Si transistor was used as a switch in the voltage converter circuit 80. The inductance L of a coil was 100 μH and the static capacitance C of a capacitor was 300 μF. An electric load 81 was connected to the output of the voltage converter circuit 80. A constant current load device was used for the electric load 81. Voltage Vout and current Iout were supplied from the voltage converter circuit 80 to the electric load 81. Voltage Vin and current Iin were supplied from a power source 91 to the voltage converter circuit 80, and voltage Vdd and current Idd were supplied from a power source 92 to the control circuit 105.

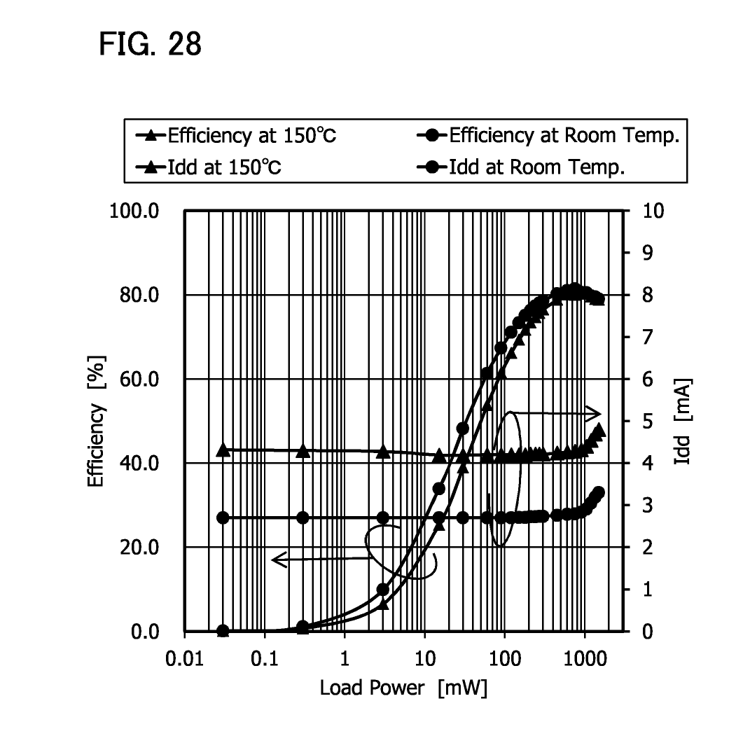

FIG. 28 shows the measurement results of the power efficiency of the DC-DC converter relative to the load power, and the current Idd consumed in the control circuit 105. FIG. 28 shows data obtained from the voltage Vin and the current Iin measured with a digital multimeter (DMM) 93, the voltage Vdd and the current Idd measured with a DMM 94, and a load current flowing through the electric load 81. The measurement was performed at room temperature, 85° C., 125° C., and 150° C. FIG. 28 shows the data of room temperature and 85° C. Even when the temperature was raised by 100° C. or higher, a significant decrease in power efficiency was not observed. The consumed current Idd was hardly changed though it was slightly higher at 150° C. than at room temperature. Specifically, the maximum power efficiency at room temperature was 81.5% in the case where Iout=250 mA and Idd=2.80 mA. The maximum power efficiency at 150° C. was 80.4% in the case where Iout=300 mA and Idd=4.31 mA.

In this example, it was found that a DC-DC converter capable of operating at 150° C. could be obtained by constituting a control circuit with only OS transistors.

This application is based on Japanese Patent Application serial No. 2013-159082 filed with Japan Patent Office on Jul. 31, 2013, and Japanese Patent Application serial No. 2014-051689 filed with Japan Patent Office on Mar. 14, 2014, the entire contents of which are hereby incorporated by reference.

What is claimed is:

1. A control circuit comprising:
an analog-digital converter circuit;
a logic unit electrically connected to the analog-digital converter circuit;
a digital-analog converter circuit electrically connected to the logic unit; and
a comparator electrically connected to the digital-analog converter circuit,
wherein the analog-digital converter circuit is configured to generate a first digital signal based on a voltage of an input signal,
wherein the logic unit is configured to generate a pulse width modulation signal based on the first digital signal,
wherein the pulse width modulation signal determines a pulse width of a pulse signal,
wherein the logic unit is configured to divide an input reference clock signal to generate an m-bit second digital signal,
wherein the digital-analog converter circuit is configured to convert the m-bit second digital signal into an analog signal to generate a 2^{m}-level triangular wave signal,
wherein m is greater than or equal to 2, and
wherein the comparator is configured to compare the pulse width modulation signal with the 2^{m}-level triangular wave signal to output a comparison result as the pulse signal.

2. The control circuit according to claim 1,
wherein the analog-digital converter circuit comprises a transistor including an oxide semiconductor layer which includes a channel formation region.

3. The control circuit according to claim 1,
wherein the logic unit comprises a transistor including an oxide semiconductor layer which includes a channel formation region.

4. The control circuit according to claim 1,
wherein the digital-analog converter circuit comprises a transistor including an oxide semiconductor layer which includes a channel formation region.

5. The control circuit according to claim 1,
wherein the comparator comprises a transistor including an oxide semiconductor layer which includes a channel formation region.

6. A DC-DC converter comprising:
a voltage converter circuit comprising;
an input terminal to which a first voltage is input;
an output terminal from which a second voltage is output; and
a transistor;
a feedback circuit electrically connected to the voltage converter circuit; and
a control circuit comprising:
an analog-digital converter circuit electrically connected to the feedback circuit;
a logic unit electrically connected to the analog-digital converter circuit;
a digital-analog converter circuit electrically connected to the logic unit; and
a comparator electrically connected to the digital-analog converter circuit and the transistor,
wherein the feedback circuit is configured to monitor a change in a voltage of the output terminal and generate a feedback signal based on the change in the voltage of the output terminal,
wherein the analog-digital converter circuit is configured to generate a first digital signal based on a voltage of the feedback signal,
wherein the logic unit is configured to generate a pulse width modulation signal based on the first digital signal,
wherein the pulse width modulation signal determines a pulse width of a pulse signal,
wherein the logic unit is configured to divide an input reference clock signal to generate an m-bit second digital signal,
wherein the digital-analog converter circuit is configured to convert the m-bit second digital signal into an analog signal to generate a 2^{m}-level triangular wave signal,
wherein the comparator is configured to compare the pulse width modulation signal with the 2^{m}-level triangular wave signal to output a comparison result as the pulse signal,
wherein m is greater than or equal to 2, and
wherein the pulse signal controls on and off of the transistor.

7. The DC-DC converter according to claim 6,
wherein the analog-digital converter circuit comprises a transistor including an oxide semiconductor layer which includes a channel formation region.

8. The DC-DC converter according to claim 6,
wherein the logic unit comprises a transistor including an oxide semiconductor layer which includes a channel formation region.

9. The DC-DC converter according to claim 6,
wherein the digital-analog converter circuit comprises a transistor including an oxide semiconductor layer which includes a channel formation region.

10. The DC-DC converter according to claim 6,
wherein the comparator comprises a transistor including an oxide semiconductor layer which includes a channel formation region.

11. A DC-DC converter converting a first voltage into a second voltage, the DC-DC converter comprising:
a voltage converter circuit comprising:
an input terminal to which the first voltage is input;
an output terminal from which the second voltage is output; and
a transistor;
a feedback circuit; and
a control circuit comprising:
a comparator; and
a buffer circuit,
wherein the feedback circuit is configured to monitor a change in a voltage of the output terminal and generate a feedback signal based on the change in the voltage of the output terminal,
wherein the comparator is configured to generate a pulse signal based on a change in a voltage of the feedback signal,
wherein a signal output from the comparator is input to a gate of the transistor through the buffer circuit, and
wherein each of the comparator and the buffer circuit comprises a transistor including an oxide semiconductor layer which includes a channel formation region.

12. The DC-DC converter according to claim 11,
wherein the oxide semiconductor layer comprises indium, gallium, and zinc.
